(19) United States
(12) Patent Application Publication
(10) Pub. No.: US 2016/0155107 A1
(43) Pub. Date: Jun. 2, 2016

(54) IMPROVED PERFORMANCE IN INTERACTION SYSTEMS

(71) Applicant: ECREBO LIMITED, Marlow Buckinghamshire (GB)

(72) Inventors: Hassan Haijji, Marlow, Buckinghamshire (GB); Yosuke Ozawa, Marlow, Buckinghamshire (GB); Roman Valiusenko, Marlow, Buckinghamshire (GB)

(21) Appl. No.: 14/905,715

(22) PCT Filed: Jul. 16, 2014
(86) PCT No.: PCT/GB2014/052177

§ 371 Date: Jan. 15, 2016

(30) Foreign Application Priority Data
Jul. 16, 2013 (GB) 1312716.2

(51) Int. Cl. G06Q 20/20; G06Q 20/34

(52) U.S. Cl. CPC G06Q 20/202; G06Q 20/204; G06Q 20/34

(57) ABSTRACT

A transaction computing device for interacting with a POS system, the POS system comprising a POS terminal having a software module for processing transactions within a transaction environment and a physical device in communication with the POS terminal, the transaction computing device comprising: an input for receiving transaction data from the physical device; a processor arranged to process the received transaction data to generate modified transaction data; an output arranged to send the modified transaction data to the POS terminal wherein the processor is arranged to: determine whether the received transaction data is associated with a unique identifier and, in response to determining the presence of an associated unique identifier, determine the state of the unique identifier; in response to the unique identifier being valid, retrieve a modified identifier, the modified identifier being in a format compatible with the POS terminal; generate modified transaction data, the modified transaction data comprising the modified identifier.

### FIELD OF THE INVENTION

The present invention relates to a method of enhancing point of sale systems. In particular, the present invention relates to a method of enhancing the functionality of a point of sale system, such as that found within a retail environment, without the need to alter either the point of sale hardware or to alter the software loaded thereon.

### BACKGROUND OF THE INVENTION

Retailers use point of sale hardware and software systems (POS systems) to streamline sales operations and to allow them to process sales, handle payments, and store transactions for later retrieval. POS systems generally comprise a number of elements including point of sale terminals that are connected to a controlling server (the “back-office” servers) using an internal network connection. In a large retail environment, such as a supermarket, there may be a plurality of such POS terminals in communication with the back-office servers. It is noted that the back-office servers may be located locally (e.g. within the store) or remotely (in which case the POS terminals may be in communication with the back-office servers via a local communications network and a further communications network such as the Internet).

POS systems represent a very expensive investment for retailers. Retailers choose their POS provider after a lengthy Request for Proposal (RFP) process, and once the investment is made, they upgrade it only infrequently.

Extending the functionality of POS systems has always been a challenge but the recent popularity of coupons and the proliferation of mobile phones have put tremendous pressure on retailers to look at ways at supporting these functionalities as quickly as possible. Clearly, it is always possible to redesign and develop the POS software so that it supports issuance and redemption of coupons, and integrate with mobile channels, but this option is costly and time consuming.

FIG. 1 shows a typical POS configuration for a point-of sale system 1 comprising a POS terminal 3, a receipt printer 5, a barcode scanner 7, a data entry device 9 for the entry of PIN codes (the “Pin Pad”), back-office servers 11 and a payment processing server 13. The POS terminal, back-office servers 11 and payment processing server 13 are in communication with one another via a network 15 (which may be a local network, the Internet or a mixture of both).

The POS terminal 3 comprises a point of sale application software module 17, which is in communication with a product database 19, and a payment application software module 21.

The point of sale application software module 17 and payment application software module 21 are each in communication with the receipt printer 5 and scanner 7 and with the back-office servers 11 and payment processing server 13 via the network 15.

The point of sale application software module 17 is responsible for recording items to be sold one by one, calculating the total balance, triggering any pre-configured promotions, and then accepting multiple payment methods. Typically, items are input in using the scanner 7. Items having barcodes printed on external packaging will be placed in front of the scanner 7 which then scans the barcode and passes the barcode as input to the POS software module 17. The POS software module 17 will then query the local database 19 to retrieve the price of the item which may be displayed on a screen (not shown in FIG. 1).

Once all items are scanned, the cashier asks the customer to confirm their preferred payment type to use, and if the user chooses to pay by card, the POS software module 17 connects to the payment application software module 21.

The payment application software module 21 drives an external device 9 to get the credit card details and optionally the PIN associated with the card. In cases where a PIN code is not required, the payment application software module may interface with a magnetic strip reader (which may be integrated with the device 9) which reads the card details when the user or cashier swipes the card through the strip reader.

Once the transaction is paid for, the POS application software module 17 formats details of the transaction and sends them to the receipt printer 5. In many cases, two or more receipts are printed: one for the customer, and one of the retailer. It is noted that the retailer copy of the receipt can potentially contain more information than the customer one (for e.g. full card details, while the customer receipt contains only the last 4 digits of the card used).

The payment application software module 21 is responsible for authenticating the card, verifying the PIN, and authorizing the card for payment. This is done by accessing the payment processor 13 over the network connection 15. The payment processor 13 may be either hosted inside or outside the premises of the retailer, and in that case it is hosted outside the retailer's premises, the network path from the payment application software module 21 to the payment processor 13 may involve leaving the retailer's local computer network and using the Internet or other communications network (e.g. dedicated communications network or a mobile telecommunications network). The network 15 is also used by the POS application software module 17 to send transaction details to the back-office servers 11.

The POS application software module 17 typically runs on a commodity operating system (e.g. Microsoft Windows or Linux). Each of the devices external to the POS terminal 3 is connected to the machine using standard connectors: Serial, Parallel, USB, or Ethernet ports. To simplify the interoperability between POS software and payment software vendors and external devices vendors, a consortium of companies led by Microsoft, NCR, Epson, and Fujitsu-ICL standardised the interface between each device. These standards are typically implemented in Java or COM technologies, and known under the name of JAVAPOS or OPOS.

It is noted that OPOS is an implementation of an interoperability standard for a Windows® operating system using Component Object Model (COM) technology. OPOS defines a set of control objects that define the interface of each device, and a set of service objects that implement the interface above, in a set of libraries called service objects. Typically, the service object is provided by the hardware provider (e.g. Epson for the printers).

JAVAPOS is the implementation of the standard in JAVA language. It uses the same architecture as OPOS, with a set of JAVA classes defining the interface of the API, and another set of JAVA classes defining the implementation of these interfaces, called service objects. Typically, the manufactures provides the implementation for these service objects in JAVA.

FIG. 2 shows a typical layout of the component of OPOS used to interface between a physical device 23 (e.g. the printer 5 or scanner 7 of FIG. 1) and the POS application software module 17. The POS application software module 17 is arranged to access the physical device 23 using a standard OPOS application programming interface (API) 30. Communication between the POS application software module 17 and the physical hardware device 23 is handled by an OPOS device 32 (which is actually a software stack within the POS terminal 3).

The OPOS device comprises an OPOS device control module 34 which provides the interface for the POS application software module 17 and an OPOS device service module 36 which provides communication to the device 23.

The OPOS Device Service module 36 implements the details of the physical device 23 and is typically provided by the hardware vendor. For example, to print receipt data, the POS application software module 17 may call the following method:
PrintNormal (Integer Station, String DataToBePrinted):
Prints the data specified in “DataToBePrinted” to the station specified in parameter “Station”. This is guaranteed to work regardless of the underlying printer attached to the POS terminal 3.

Similar APIs exist for the scanner 7 as well. For example, regardless of the scanner attached to the POS terminal 3, the scanner property called “ScanData” always holds the scanned data. The POS application software module 17 upon receiving a read event from the scanner, can read this data, and it is guaranteed to hold the barcode of the item scanned.

An arrangement mirroring that of FIG. 2 may also be used to describe a JAVAPOS system for interfacing a POS software module with a hardware device.

To access the stream of data sent by the POS application software module 17 requires a change in the application so that appropriate code can be added in order to access the data.

It is noted that retailers are looking for ways to understand their customers, to reach them through a multitude of channels, to leverage mobile phones as another channel to engage with their customers and to collect information about the experience of customers in their stores. Typically, any of these actions would require major changes to be made to POS software and hardware.

For example to be able to collect information about customers, retailers have been using loyalty cards to build profiles of customers. While popular, loyalty cards are very expensive to manage. It costs more than £6 million to just manage the IT infrastructure required for loyalty cards. Offers associated with loyalty cards often still have to be sent using postal services, which is not only costly, but needs to be carefully planned ahead of time: retailers need to know what offers to give, in what quantity. Furthermore, if an offer is not performing as expected, there is no way to correct-course during the campaign.

To reach out to customers with offers in real-time, a retailer may opt to use a second printer to print coupons or vouchers at the point of sale till. However, retailers who implement this solution are required to operate a loyalty card scheme, a set of colour printers and targeting software which is very costly. A single printer of the type used by these retailers has a retail price of hundreds of pounds and, for larger environments with multiple point of sale terminals this solution is therefore very costly.

It can therefore be appreciated that modifying the standard point of sale environment is a significant undertaking requiring access to transaction data (which therefore requires the POS hardware and/or software to be modified), associating transaction data with a loyalty card, and having another piece of software print offers through a second printer.

Coupons and vouchers may also be issued using other channels (such as SMS, MMS, e-mail etc.).

The vouchers and coupons that are issued may comprise identifier information, often in the form of a linear or matrix barcode, which are used on redemption to validate a coupon or voucher. If the identifier information is the same per campaign, it may be referred to as a static identifier.

A system that involves voucher and coupon with static identifiers does not usually require communication over a network with other services on issuance or redemption. However, the downside of this approach is that it may be possible for coupons or vouchers to be redeemed multiple times. Moreover, redeemed coupons must go through a time-consuming, error-prone and fraud-prone clearing-house system later, the problems of which are highlighted in US2008/0133365A1.

Paper based vouchers or coupons may be especially susceptible to financial risk (on the part of the retailer/offer entity) since improvements in copying technologies have made it easier to reproduce vouchers (see EP 2 299 397).

A number of prior systems relating to the issue of vouchers at a point of sales system are known. The problem of over-usage of vouchers or coupons is also known and various method to prevent it have been proposed.

In EP 2 299 397 a method for voucher redemption is given. The method uses EFTPOS to process redemption. However, setting up this system requires modification to existing systems or software which is undesirable as noted above.

In U.S. Pat. No. 6,415,983 over-usage of post stamps is addressed in which the stamps are checked against a national circulation database.

It is therefore an object of the present invention to provide a mechanism for modifying/enhancing the functionality of a point of sale system without requiring the addition of new hardware and without requiring the modification of POS provider proprietary software modules such that vouchers/coupons may be issued and redeemed and such that the issue of double usage is prevented/detected or mitigated against.

### SUMMARY OF THE INVENTION

According to a first aspect of the present invention there is provided a transaction computing device for interacting with a POS system, the POS system comprising a POS terminal having a software module for processing transactions within a transaction environment and a physical device in communication with the POS terminal, the transaction computing device comprising: an input for receiving transaction data from the physical device; a processor arranged to process the received transaction data to generate modified transaction data; an output arranged to send the modified transaction data to the POS terminal wherein the processor is arranged to: determine whether the received transaction data is associated with a unique identifier; and, in response to determining the presence of an associated unique identifier, determine the state of the unique identifier; in response to the unique identifier being valid, retrieve a modified identifier, the modified identifier being in a format compatible with the POS terminal; generate modified transaction data, the modified transaction data comprising the modified identifier.

The transaction computing device is arranged to receive transaction data from a physical device (e.g. printer or scanner) of a point of sale system. The point of sale system conveniently is arranged to comprise a virtual driver (as described herein) to thereby allow data in the data stream between the POS terminal and the physical device to be sent to and received from the transaction computing device.

The transaction data may relate to unique barcode data that is scanned by a scanner device or loyalty card data that is scanned by the scanner device.

POS systems comprise proprietary hardware and software that is difficult and/or expensive to modify. Known POS systems are unable to process unique barcode entities (unique identifiers) and so the transaction computing device according to the first aspect of the present invention is arranged to detect the presence of such unique identifiers in the transaction data and to retrieve a modified identifier that is compatible with the POS terminal. Modified transaction data can then be generated by the transaction computing device and inserted into the data stream to the POS terminal.

The transaction computing device according to the first aspect of the present invention therefore effectively extends the capabilities of a known POS system by enabling scanned unique identifier data that would otherwise not be recognised to be substituted with data that the POS system can process. This in turn enables fraudulent usage of barcodes to be minimised.

[In order to prevent (or minimise) fraudulent usage, the barcode (voucher identifier) printed on a coupon or a voucher should be unique, meaning that the coupon or a voucher is different each time it is issued; and it should be complex enough that the code equivalent to a valid voucher cannot be easily generated. Once redeemed it is marked as redeemed in a database accessible by all point of sales in the retailer network, preventing from multiple redemption.

However, introduction of such system to existing retailer's infrastructure usually requires changes to POS software or hardware, which can be quite challenging and expensive.

The present invention gives the method and system for vouchers or coupons issuance with unique identifiers, usually in form of linear or matrix barcodes, validation and redemption of the vouchers or coupons issued by the system, without the need to alter either the point of sale hardware or to alter the software loaded thereon. The present invention also gives a method to enhance the POS system with services related to customer identifiers such as points or automatic offers redemption, without the need to alter either the point of sale hardware or to alter the software loaded thereon.

The proposed system (transaction computing device) simplifies coupon and voucher clearance, since it simplifies not only counting of issued and redeemed coupons, but also allows to query additional information such as at which point of sale a coupon or a voucher has been issued or redeemed, how many times, and when it was actually issued and used.]

The transaction computing may further comprise a data store wherein the computing device is arranged to store unique identifiers present in the received transaction data. This data store (referred to below as an accumulator module) enables scanned unique identifiers to be stored for later checking against receipt data. This in turn enables the system to mark unique identifiers as used only when a given transaction is completed.

The input may be arranged to receive further transaction data relating to a completed transaction; and wherein the processor is arranged to determine whether the further transaction data comprises a transaction entity corresponding to the unique identifier and, in response to determining the presence of such a transaction entity to update the state of the unique identifier. In this manner receipt data may also be received by the transaction computing device and this data analysed to check whether it comprises data that corresponds to the previously scanned unique identifier (such a transaction entity may comprise a voucher name, reference code or other identifier). If such data is present in the receipt data then the state of the unique identifier (e.g. valid, issued) may be updated to indicate that the unique identifier has been used. The state of the unique identifier may then be updated from valid to used.

The computing device may be in communication with a storage module that is arranged to store the state of the unique identifier. The storage module may be remote from the transaction computing device and POS system or alternatively may comprise part of the transaction computing device.

The received transaction data is received from a physical device such as a scanner device.

The input may be arranged to receive transaction data from a plurality of POS systems and the processor may be arranged to process transaction data received from each of the plurality of POS systems and return modified transaction data to each of the plurality of POS systems. In this manner the present invention may be extended for use within a retailer network of POS systems, e.g. within a location that comprises multiple POS terminals such as a supermarket.

The input may be arranged to receive further transaction data relating to a completed transaction and wherein the processor may be arranged to determine whether the further transaction data comprises a plurality of transaction entities, each transaction entity corresponding to a unique identifier, and, in response to determining the presence of a first transaction entity, to update the state of the unique identifier corresponding to the first transaction entity and wherein the processor may be arranged to repeat the determining and state updating for each transaction entity identified in the received further transaction data. In this manner the receipt data for a plurality of POS systems and/or a plurality of unique identifiers in the transaction data may be processed.

The further transaction data may be received from the POS terminal. In other words the further transaction data may comprise print data for a printer physical device.

The processor may be arranged to determine the state of the unique identifier by accessing a look up table that comprises details of all issued unique identifiers

The unique identifier may comprise barcode data in a format incompatible with the POS terminal and the modified identifier may comprise barcode data in a format compatible with the POS terminal.

The unique identifier within the transaction data may comprise a loyalty number from a scanned loyalty card and determining the state of the unique identifier may comprise determining if the unique identifier is linked to a transaction redemption offer. It is noted that the unique identifier (the loyalty card number) may be linked to multiple redemption offers.

According to a second aspect of the present invention there is provided a transaction computing device for interacting with a POS system, the POS system comprising a POS terminal having a software module for processing transactions within a transaction environment and a physical device in communication with the POS terminal, the transaction computing device comprising: an input for receiving transaction data from the physical device; a processor arranged to process the received transaction data to generate modified transaction data; an output arranged to send the modified transaction data to the POS terminal; wherein the processor is arranged to: determine whether the received transaction data comprises a unique identifier in the form of barcode data; and, in response to determining the presence of a unique identifier, determine the state of the unique identifier; in response to the unique identifier being valid, retrieve a modified identifier, the modified identifier comprising further barcode data in a format compatible with the POS terminal; generate modified transaction data, the modified transaction data comprising the modified identifier.

The input may be arranged to receive further transaction data from the POS terminal relating to a completed transaction and the transaction computing device may be arranged to determine whether the further transaction data comprises a transaction entity corresponding to the unique identifier and, in response to determining the presence of such a transaction entity to update the state of the unique identifier.

According to a third aspect of the present invention there is provided transaction computing device for interacting with a POS system, the POS system comprising a POS terminal having a software module for processing transactions within a transaction environment and a physical device in communication with the POS terminal, the transaction computing device comprising: an input for receiving transaction data from the physical device; a processor arranged to process the received transaction data to generate modified transaction data; an output arranged to send the modified transaction data to the POS terminal wherein the processor is arranged to: determine whether the received transaction data comprises a unique identifier in the form of a loyalty number and, in response to determining the presence of a unique identifier, determine if the loyalty number is associated with a transaction redemption offer; and in response to the loyalty number being associated with a transaction redemption offer, retrieve a modified identifier, the modified identifier comprising redemption offer data in a format compatible with the POS terminal; generate modified transaction data, the modified transaction data comprising the modified identifier.

The input may be arranged to receive further transaction data from the POS terminal relating to a completed transaction; and the processor may be arranged to determine whether the further transaction data comprises a transaction entity corresponding to the transaction redemption offer and, in response to determining the presence of such a transaction entity to update the state of the transaction redemption offer.

According to a fourth aspect of the present invention there is provided a transaction computing device for interacting with a POS system, the POS system comprising a POS terminal having a software module for processing transactions within a transaction environment and a physical device in communication with the POS terminal, the transaction computing device comprising: an input for receiving transaction data from the POS terminal; a processor arranged to process the received transaction data to generate modified transaction data; an output arranged to send the modified transaction data to the software module wherein the processor is arranged to: determine whether the received transaction data comprises an identifier for a transaction redemption offer; and, in response to determining the presence of an identifier, create an association between the identifier, transaction redemption offer and a unique identifier; and generate modified transaction data, the modified transaction data comprising the unique identifier.

According to a fifth aspect of the present invention there is a method of operating a transaction computing device to interact with a POS system, the POS system comprising a POS terminal having a software module for processing transactions within a transaction environment and a physical device in communication with the POS terminal, the method comprising: receiving transaction data from the physical device; processing at a processor the received transaction data to generate modified transaction data; sending the modified transaction data to the POS terminal wherein the processing at the processor comprises determining whether the received transaction data is associated with a unique identifier; and, in response to determining the presence of an associated unique identifier, determining the state of the unique identifier; in response to the unique identifier being valid, retrieving a modified identifier, the modified identifier being in a format compatible with the POS terminal; generating modified transaction data, the modified transaction data comprising the modified identifier.

According to a sixth aspect of the present invention there is provided a method of operating a transaction computing device for interacting with a POS system, the POS system comprising a POS terminal having a software module for processing transactions within a transaction environment and a physical device in communication with the POS terminal, the method comprising: receiving transaction data from the physical device; processing the received transaction data to generate modified transaction data; sending the modified transaction data to the POS terminal wherein the processing at the processor comprises determining whether the received transaction data comprises a unique identifier in the form of barcode data and, in response to determining the presence of a unique identifier, determining the state of the unique identifier; in response to the unique identifier being valid, retrieving a modified identifier, the modified identifier comprising further barcode data in a format compatible with the POS terminal; generating modified transaction data, the modified transaction data comprising the modified identifier.

According to a seventh aspect of the present invention there is provided a method of operating a transaction computing device for interacting with a POS system, the POS system comprising a POS terminal having a software module for processing transactions within a transaction environment and a method computing device comprising: receiving transaction data from the physical device; processing the received transaction data to generate modified transaction data; sending the modified transaction data to the POS terminal wherein the processing at the processor comprises determining whether the received transaction data comprises a unique identifier in the form of a loyalty number and, in response to determining the presence of a unique identifier, determining if the loyalty number is associated with a transaction redemption offer; and in response to the loyalty number being associated with a transaction redemption offer, retrieving a modified identifier, the modified identifier comprising redemption offer data in a format compatible with the POS terminal; generating modified transaction data, the modified transaction data comprising the modified identifier.

According to an eighth aspect of the present invention there is provided a method of operating a transaction computing device for interacting with a POS system, the POS system comprising a POS terminal having a software module for processing transactions within a transaction environment and a physical device in communication with the POS terminal, the method comprising: receiving transaction data from the POS terminal; processing the received transaction data to generate modified transaction data; sending the modified transaction data to the software module wherein the processing at the processor comprises determining whether the received transaction data comprises an identifier for a transaction redemption offer and, in response to determining the presence of an identifier, creating an association between the identifier, transaction redemption offer and a unique identifier; and generating modified transaction data, the modified transaction data comprising the unique identifier.

It will be appreciated that preferred and/or optional features of the first aspect of the invention may be provided in the second to eighth aspects of the invention also, either alone or in appropriate combinations.

The invention extends to a carrier medium for carrying a computer readable code for controlling a computer or POS terminal to carry out the method of the fifth to eighth aspects of the invention.

As described above, the aspects of the present invention described above provide a method to extend any existing point of sale system and supporting payment processing system to associate full or partial payment card numbers or a loyalty card or any the derivatives of these with the details of the transaction as printed on the receipt without modifying the point of sale or payment processing software. Each full or partial card number, its derivative or loyalty card may be used as a proxy for a customer, and an offer engine may select an appropriate offer to send to that card holder. Offers may be printed as coupons at till using the same printer used for printing receipts. Offers may also be printed (by the action of the driver software module) at a second printer other than the receipt printer. Relevant offers may be sent to a customer using any connection between a POS and a customer mobile device. Transaction data printed on the receipt may be sent to a user mobile device using any connection of the mobile device to the till. The present invention provides a method to extend any existing point of sales system to intercept and modify the content of the data sent to the receipt printer without modifying the point of sale or payment processing software. Receipt data may be intercepted, modified, and sent to the receipt printer with an additional code printed on the receipt. The code may be arranged such that it may be automatically read or manually input into a mobile device, by using an application running the mobile device to thereby recover the digital format of the receipt. The additional code may be read by a mobile device and then used by an application running on the mobile device to associate the user with current transactions to build a history of transactions associated with the user. The code may be processed by the application running on the mobile device and the user may be presented with rewards, requests for feedback, or request for reviews. The code may encode a payment card, or loyalty card used, and allow the application running on the mobile device to recover the payment card used or loyalty card used (or any of their derivatives) and to use these cards to associate user with any transactions where any of these card are used. Rewards or feedback requested may be conditional on the items in a current basket, the total amount spent on a current transaction, history of purchases or rewards over any period of time. Where the scanner data is intercepted, a barcode may be verified by an external application, and then translated to code that the POS application understands.

### BRIEF DESCRIPTION OF THE DRAWINGS

In order that the invention may be more readily understood, preferred non-limiting embodiments thereof will now be described with reference to the accompanying drawings, in which:

FIG. 1 shows a known point-of-sale (POS) till configuration;

FIG. 2 shows an OPOS architecture;

FIG. 3 shows an OPOS architecture in accordance with an embodiment of the present invention;

FIG. 4 shows a known filter driver architecture;

FIG. 5 shows a filter driver architecture in accordance with an embodiment of the present invention;

FIG. 6 shows a known API structure; and

FIG. 7 shows a filter driver using hooked APIs in accordance with an embodiment of the present invention;

FIGS. 8a to 8c show further point of sale system arrangements that may be used in conjunction with embodiments of the present invention;

FIG. 9 shows a point of sale (POS) system in accordance with an embodiment of the present invention;

FIG. 10 shows the components of a transaction computing device in accordance with embodiments of the present invention;

FIG. 11 shows the different states that a unique identifier may have in accordance with embodiments of the present invention;

FIG. 12 shows an example of a data structure of a component of FIG. 11;

FIG. 13 is a flow chart of a unique identifier redemption method in accordance with an embodiment of the present invention;

FIG. 14 is a flow chart of a unique identifier issuance method in accordance with an embodiment of the present invention;

FIG. 15 is a flow chart of a unique identifier validation method in accordance with an embodiment of the present invention;

FIG. 16 is a flow chart of a unique identifier redemption method in accordance with an embodiment of the present invention;

FIG. 17 is a flow chart of a offer redemption method in accordance with an embodiment of the present invention;

FIG. 18 shows a retailer network in accordance with an embodiment of the present invention;

FIG. 19 shows a known voucher arrangement;

FIG. 20 shows a receipt arrangement;

FIG. 21 shows the process of issuing a unique identifier in accordance with an embodiment of the present invention;

FIG. 22 shows the process of redeeming an unique identifier in accordance with an embodiment of the present invention;

FIG. 23 shows the process of redeeming an offer in accordance with an embodiment of the present invention;

FIG. 24 shows a known voucher and a voucher in accordance with an embodiment of the present invention;

FIG. 25 shows scanner and printer events.

### DETAILED DESCRIPTION OF THE INVENTION

The following terms may be used in conjunction with the description of embodiments of the present invention.
Scanner—the scanner (which is also referred to as a “physical device”) is an input device capable of scanning and processing identifiers. For instance, a scanner may be arranged to scan linear or matrix codes.
Scanner Event—an event when an identifier, e.g. a barcode or a QR-code etc. is scanned.
POS terminal—the “point of sale” terminal is a machine running and processing transactions. For instance, ordinary retailer till.
Printer—the printer (which may also be referred to herein as a “Physical device”) is an output device arranged to display or print receipts, coupons, vouchers, or some other information.
Printer Event—an event when a POS Terminal sends data to a Printer to print a receipt or some other information.
Checkout System—a checkout system (which is also referred to herein as a “POS system”) comprises a POS Terminal, a scanner, and a printer.
Retailer Network—comprises a set of checkout/POS systems.
POS-Entity—a POS entity comprises a physical or electronic entity that may be processed by the POS terminal. An example of a POS-entity would be a linear or matrix barcode data that has been processed by scanner. It is noted that traditional POS terminals may be capable only of processing certain types of barcode. In other words, only barcodes corresponding to a certain format (or formats) may be processed by such a POS terminal.
UID—relates to a unique identifier
UID-Metadata—relates to extra information about UID. For instance, a specific UID may be associated with a coupon/voucher name or some offer information.
UID-Tag—a tuple of a POS-Entity and UID-Metadata.
UID-State—a UID state (e.g. valid, used etc.)
Validation-Result—a tuple consisting of validity, a boolean result, and UID-State.
Issuance—an event when an identifier (e.g. a coupon or a voucher is being output) using a printer.
Redemption—an event when an identifier, e.g. a coupon or a voucher is being redeemed.
Validation—a process during which the state of an identifier is ascertained to determine if it is valid for redemption.
Burning—a process of flagging that an identifier, e.g. a coupon or a voucher, has been used in order to prevent multiple redemptions.
Session—the time period between a first scanner event (SE_i) after the last printer event (PE_i) or after a POS terminal has been rebooted until the next printer event (see FIG. 25)

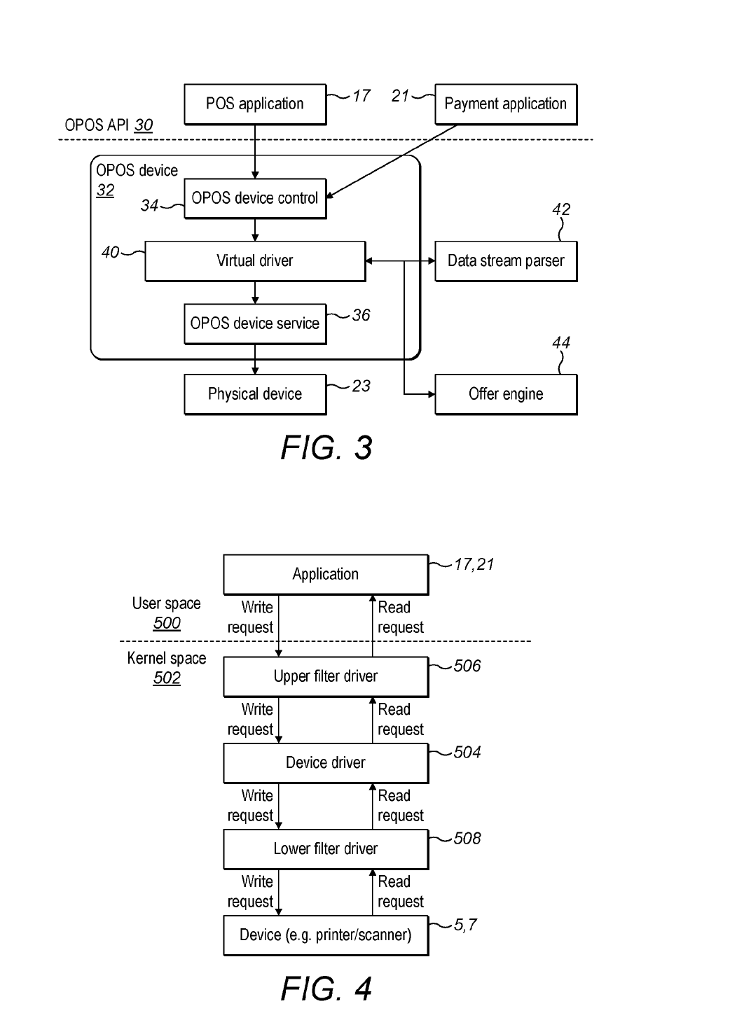

FIG. 3 shows a POS system suitable for use with embodiments of the present invention. It is noted that like numerals are used to denote like features throughout the claim set.

The architecture depicted in FIG. 3 is similar to the known OPOS architecture of FIG. 2. The OPOS device 32 however now additionally comprises a virtual physical driver software module 40 that is located between the OPOS device control module 34 and the OPOS device service module 36.

The inclusion of the driver software module 40 enables data communications to and from the POS application software module 17 or payment application software module 21 to the physical device 23 to be monitored and intercepted. The driver software module 40 also enables data communications that originate from outside the POS system 1 to be inserted into the OPOS device 32 and routed to either the physical device 23 or the POS application 17/payment application 21 software modules. In this manner information relating to transactions can be extracted from the POS system 1 and additional information can be added into the communication path between the POS terminal 3 and physical devices (5, 7).

In more detail the virtual driver software module 40 may be installed and operated as follows:

In an installation step the virtual physical driver software module 40 may be installed onto the POS terminal 3 such that it sits between the OPOS device control software module 34 and the OPOS device service software module 36.

In a first operational step, each command passed through from either the POS application software module 17 or the payment application software module 21 to the physical device 23 may be monitored and passed to a data stream parser module 42.

In a second operational step, the data stream parser module 42 may parse the data to create a list of transaction items; total amount spent; details of any promotions; cashier name or id; and/or any other data of interest. The data stream parser 42 may be achieved using a regular expression parser. The stream parser 42 may also parse the details of the cards used (either partial details, such as last 4 card digits and expiry date, or complete details if available). It is noted that since the payment application software module 21 uses the stack OPOS device 32, the virtual physical driver module 40 may also intercept any extra information used when printing the retailer receipt (in case the retailer receipt contains full card details).

In a third operational step the virtual physical driver module 40 may pass the card and transaction data derived in the second step above to a computing device 44. The computing device 44 may comprise a module associated with the POS system 1, a separate local computing device or a remotely located device. (It is noted that the computing device 44 is also referred to herein as a “transaction computing device”)

In a fourth operational step the computing device 44 may return modified data to the virtual physical driver module 40 which can then be supplied via the OPOS device service software module 36 to the physical device 23. In the example where the physical device 23 is the receipt printer 5 this allows the modified data (or a part or representation thereof) to be printed onto the customer's receipt.

In one example the computing device 44 may be an offer engine and depending on rules pre-set within the offer engine (e.g. to serve an offer to any customer who spent more than £20), the offer engine may generate an offer and pass it to the virtual physical driver module 40 for printing. Once the standard receipt data (e.g. store details, transaction items, transaction details etc.) has been printed, the virtual physical driver module 40 may print the offer received above to the POS system's receipt printer 5.

The virtual physical driver module 40 described above allows existing POS hardware to be used without any alterations to achieve the following:
Intercept transaction details without needing to modify the POS application software module 17;
Provide information from a computing device 44 to a customer using existing hardware (i.e. the receipt printer 5);
Associate transaction details with card details to thereby enable a loyalty scheme to be operated without any sign-up or loyalty cards to be used.

It is also noted that a POS terminal software module (either POS application software module 17 or Payment application software module 21) may in certain circumstances communicate directly with a physical hardware device rather than using an OPOS or JAVAPOS interface. Two alternative arrangements are therefore envisaged: (i) the software module (17, 21) may use ESC/POS (a command language used to drive receipt printers) or a similar language to directly to write to a serial port on the hardware device or to a USB device, or (ii) the software module may use a high-level printing API (for e.g. Windows printing architecture) and send rasterised data to the connected hardware device.

In arrangement (i) above, the data sent to the printer is a digital copy of the receipt and can be parsed as text. In arrangement (ii) above, the data sent to the printer is binary, and a parsing program would not be able to readily recover the details of the transactions.

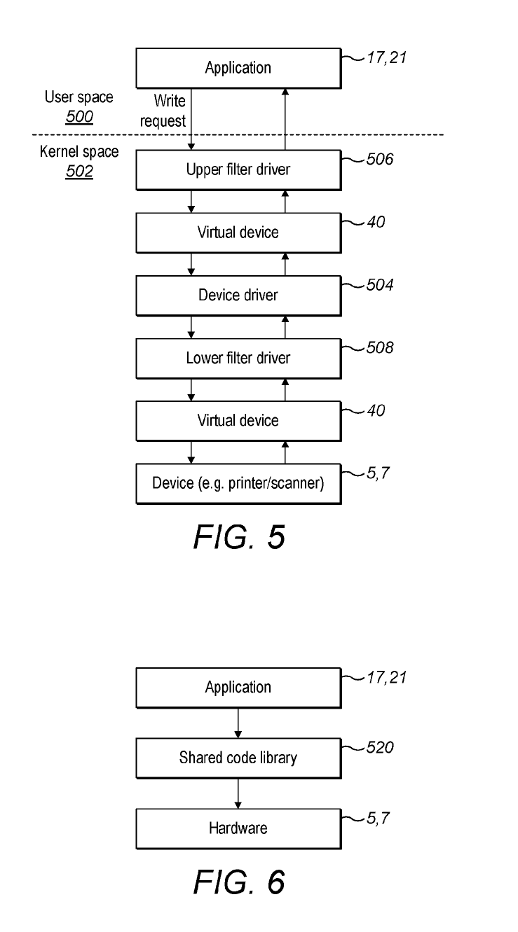

In arrangement (i), the virtual driver software module 40 may be implemented as a filter driver as shown in FIGS. 4 and 5. FIG. 5 shows a known POS terminal environment prior to modification in accordance with an embodiment of the present invention comprising a user space 500 and a kernel space 502 in which an application 17, 21 may read and write data to a physical device (5, 7) via a device driver 504 and upper (506) and lower (508) filter drivers.

It is noted that filter drivers are Microsoft Windows drivers that add value to peripheral devices or support specialized devices in a computing device. A filter driver is a driver/program/module that is inserted into an existing driver stack to perform some specific function. A filter driver should not affect the normal working of the existing driver stack in any major way. Written either by Microsoft® or the vendor of the hardware, any number of filter drivers can be added to Windows®. Upper level filter drivers sit above the primary driver for the device (the function driver), while lower level filter drivers sit below the function driver and above the bus driver.

Filters may work on a certain brand of device such as a mouse or keyboard, or they may perform some operation on a class of devices, such as any mouse or any keyboard. Another type of filter driver is the bus filter driver, which may be added on top of the bus driver. For example, an ACPI bus filter is added to support power management for each device.

Turning to FIG. 5, an embodiment of the present invention is shown in which it can be seen that the virtual device software module 40 may be implemented as a filter driver either below the upper filter driver 506 or below the lower filter driver 508.

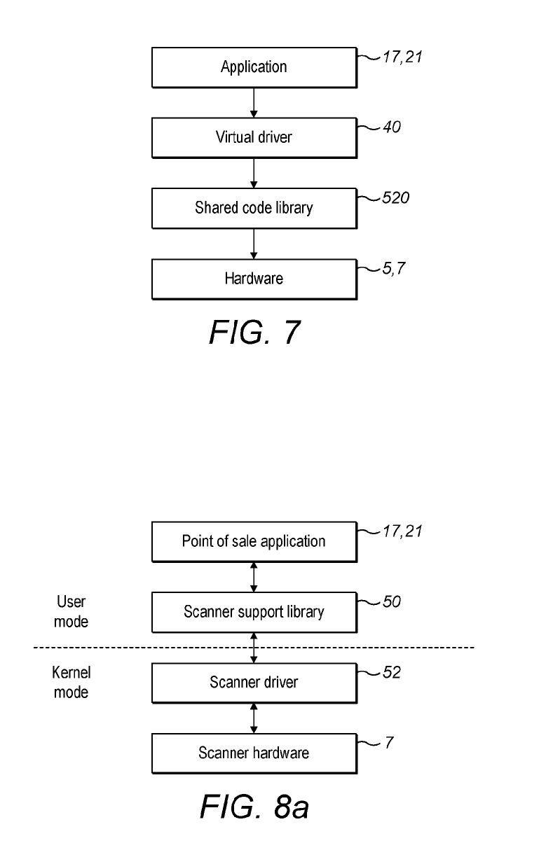

In arrangement (ii), the virtual driver may be implemented as a library that hooks the original API provided by the operating system with its own API hook. The virtual driver 40 may then transfer the API calls to the original library 520 provided by the operating system as shown in FIGS. 6 and 7.

Most OPOS or JAVAPOS service objects end up communicating with the hardware using the hardware driver installed in the OS. In this case, the virtual driver software module 40 may beneficially be installed as a filter driver and in the JAVPOS or OPOS layer. The reason is that changing the drivers stack to add a filter driver may be easier than changing the configurations of JAVAPOS and OPOS layers to accept an extra virtual device in the stack.

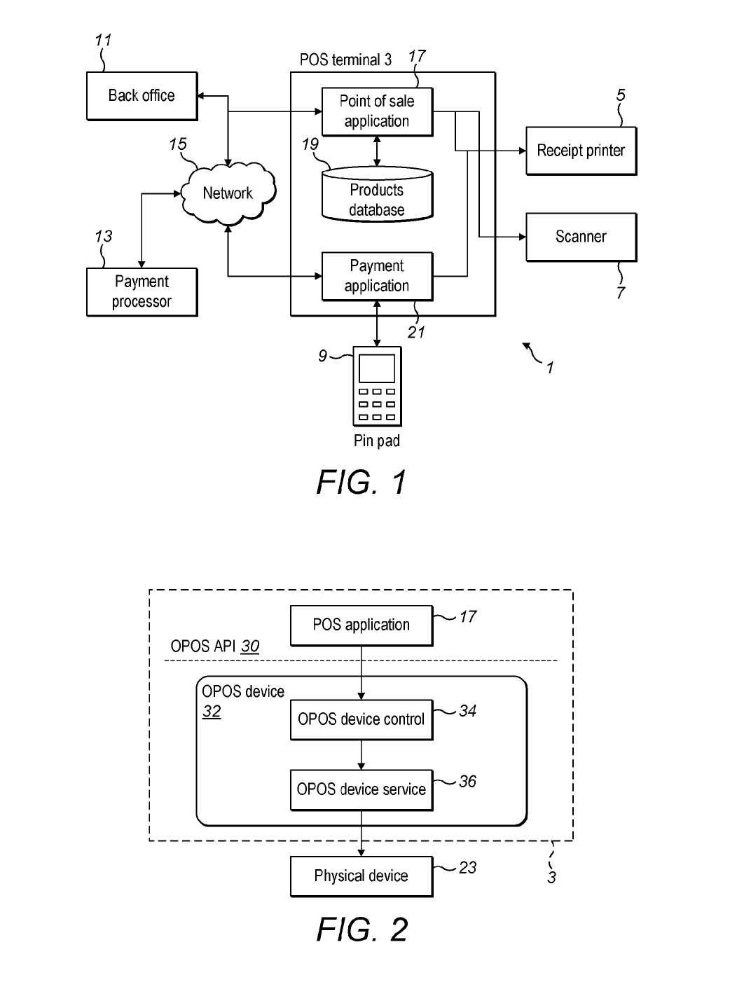

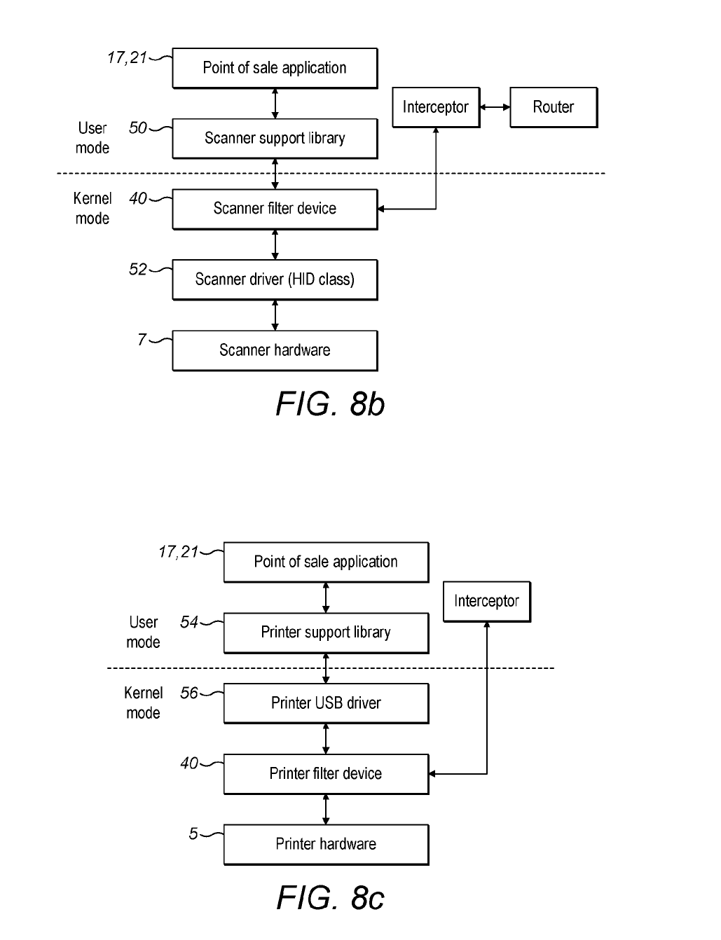

Further POS system arrangements that may be used in conjunction with embodiments of the present invention are shown in FIGS. 8a, 8b and 8c. FIG. 8a shows a scanner arrangement on a known system such as that shown in FIG. 1. A point of sale application (17, 21) located in the user mode of the POS terminal 3 is in communication with a scanner support library 50 (also in the user mode). This library in turn is in communication with a scanner driver 52 and the canner hardware 7.

In FIG. 8 the virtual drive 40 described above is shown. FIG. 8c shows the arrangement for the printer hardware 5 and the arrangement comprises a printer support library 54 and printer USB driver 56.

FIGS. 8b and 8c also show an interceptor module and router module which are explained in more detail below.

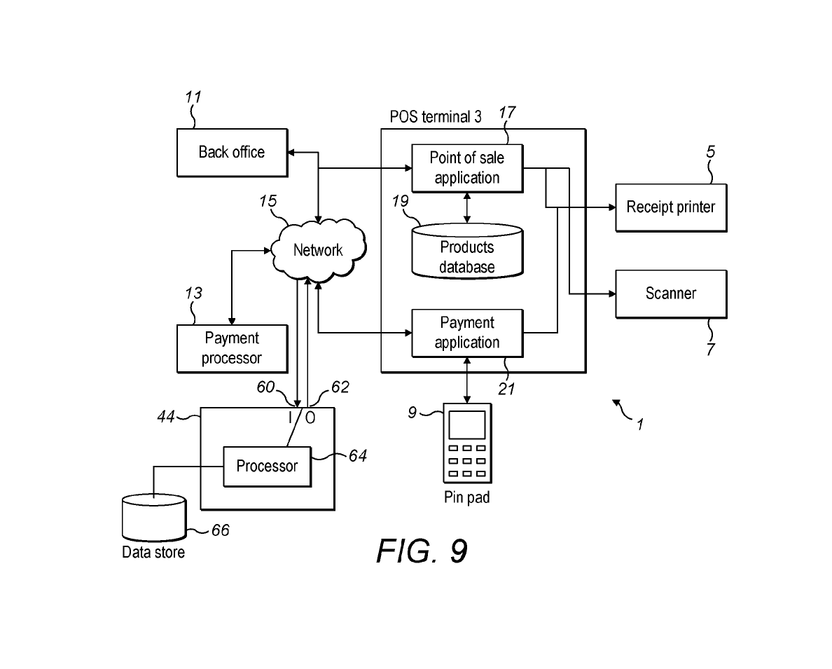

FIG. 9 shows a point-of-sale system in accordance with an embodiment of the present invention. Like reference numerals with the system of FIG. 3 are used to denote like features. It is noted that the arrangement of FIG. 9 additionally comprises a computing device 44 having an input 60 for receiving scanning and printing data from the POS terminal 3 and an output 62 for sending modified printing and scanning data to the POS terminal 3.

The computing device 44 further comprises a processor 64 arranged, amongst other things, to determine the presence of voucher or loyalty card data within the scanned data stream, to convert said data into a format compatible with the POS terminal and to manage the status of issued voucher codes. The computing device may be in communication with or comprise a data store 66 for storing transaction related data.

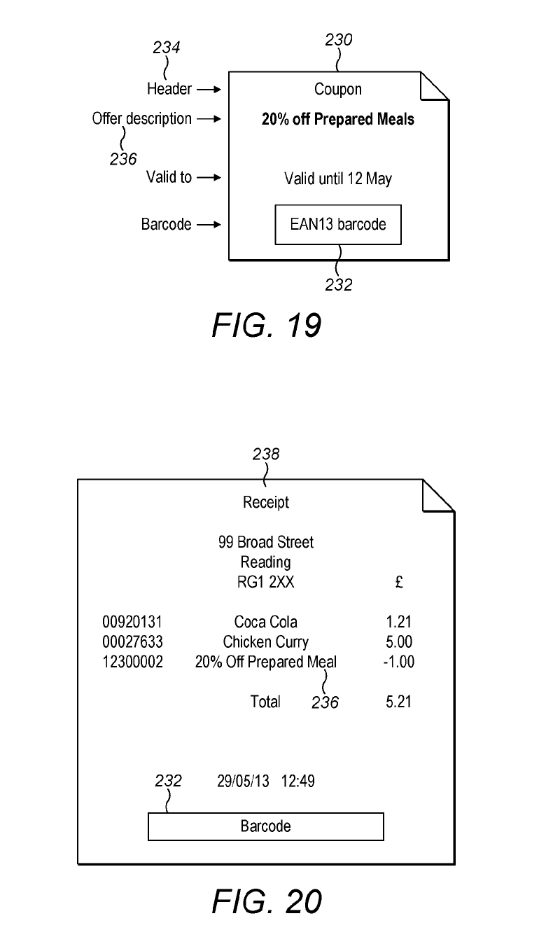

As explained above, the virtual driver module 40 may be used to issue coupons and vouchers with a barcode printed on them (see FIGS. 19 and 20 for examples). In cases where retailers want to check that each bar code is valid and also has not been used before, the computing device 44 as shown in FIG. 9 may be applied to data received from the scanner 7 so that coupons and vouchers may be validated.

The computing device 44 of FIG. 9 may also be applied to voucher data received from the scanner where the voucher was created by a third party, i.e. where the voucher has not previously been printed by the printer 5.

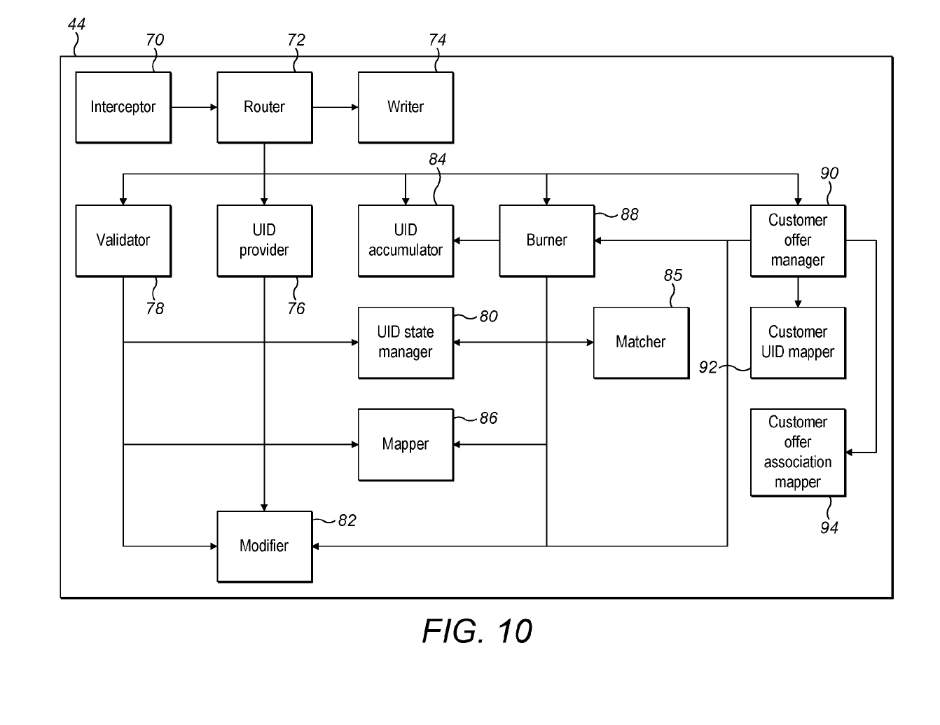

The driver software module (40) described above is a filter device driver that installs itself between the software module (17, 21) within the POS terminal 3 and the physical device 23, i.e. between the POS terminal 3 and the scanner 7 and between the POS terminal 3 and the printer 5. Data flowing within the POS system is then intercepted and sent to the computing device 44. FIG. 10 shows the structure of an embodiment of the present invention in further detail. FIG. 10 shows a number of computing modules that are either located within the computing device 44 or in communication with the computing device 44. These modules are shown within feature 44 in FIG. 10 but it is noted that some of the modules depicted may not be physically present within the device 44.

The intercepted data is sent initially to the Interceptor module 70.

The computing device 44 shown in FIG. 10 comprises a number of components which are detailed below:
Interceptor 70 and router modules 72 are used to receive data from either the physical devices (scanner or printer) or from the POS terminal.
A writer module 74 which is arranged to write transaction data to a data store 66 for analytics purposes. This module may be called during any of the issuance, redemption, validation and customer loyalty processes described below.
UID provider module 76 which is arranged to supply unique identifiers (UIDs) during an initial issuance process.
A Validator module 78 which is arranged to check the validity of unique identifiers by calling a UID state manager module 80 which stores the state of all unique identifiers issued by the system according to embodiments of the present invention.
A Modifier module 82 which is arranged to modify either scanning data from the scanner for onward transmission to the POS terminal or to modify print data from the POS terminal for onward transmission to a printer.
A UID accumulator module 84 which is arranged to temporarily store unique identifier data and/or loyalty data during a redemption and validation process.
A Mapper module 86 which is arranged to map unique identifiers issued by the system according to embodiments of the present invention to redemption offers and POS-entities that may be processed by the POS terminal.
A Burner module 88 which is arranged to instruct the UID state manager module 80 to update the state of a unique identifier to used once a redemption process has completed.
Embodiments of the present invention also relate to a loyalty card use. The computing device 44 also comprises, in relation to this embodiment, a customer offer manager module 90 which is arranged to manage the processing of loyalty card data; a customer UID mapper module 92 which is arranged to map loyalty card data to customer unique identifier data that is linked to redemption offers; and, a customer offer association (COA) mapper module 94 which is arranged to store relationships between CUID data and redemption offers.

For clarity the structure of the computing device 44 is described first in the context of a read operation from the scanner 7 and then in the context of a print operation from the printer 5.

During the scanning operation, the POS application 17 issues a read command and when data is available from the scanner 7, the read is completed and a data packet flows from the scanner hardware 7 to the upper device stack all the way to the POS software module 17.

In doing so, the data packet traverses the Scanner Filter Driver (the driver software module 40) which sends the data packet to the interceptor module 70 within the computing device 44.

The interceptor 70 is arranged to determine if the packet conforms to a data arrangement that necessitates an information lookup on the Router module 72. If so, a lookup call is performed and if any data is available, such data is sent down to the filter driver 40. The filter driver 40 then modifies the received packed to contain the new data instead of the one received from the scanner hardware 7.

If the scanner data does not conform to a data arrangement that requires further processing (e.g. because it does not contain any identifiers for processing) then this is indicated to the driver software module 40 (the Scanner Filter Driver), which allows the originally scanned data packet to flow through to the POS application software application 17 on the POS terminal 3.

It is noted that the role of the driver software module 40 (the scanner filter driver) is to intercept data flowing from the scanner hardware to the POS application software module such that the Interceptor module may examine it.

A similar effect may also be achieved using the OPOS or JAVAPOS where the service object is modified as to be a customer built library that implements all the OPOS/JAVAPOS API through delegating all of them to the original OPOS/JAVAPOS service but modifying only those related to the scanned data when necessary. For example, ScanData property will be read from the original OPOS/JAVAPOS service object, and if it follows a pattern that necessitates a server lookup on the Router module, it will carry out the lookup and if data is available as part this lookup, it will raise the proper DataEvent (i.e. signalling that new scan event is available), but modifying the ScanData to be the one received from the server (Achieving the same effect as above).

The POS application software module reads data by using ReadFile or equivalent API. Again, one can achieve the same affect as above by hooking this API and providing a custom built ReadFile that modified read-data only when needed.

Turning back to the arrangement shown in FIG. 10, the Accumulator module 84 (also referred to herein as the SE Accumulator or Scanner event accumulator module) is called by the Router module 72 when the Router determines that the data packet intercepted between the scanner 7 and the POS terminal 3 should be stored for later use.

For instance, during a redemption process unique identifiers identified within the scanned data packet are stored, as described below, for processing once a transaction has been completed. This stored identifier information is persistent throughout a POS session.

The Validator module 78, as shown in FIG. 10, is called by the Router module 72 when the data intercepted between the scanner 7 and the POS terminal 3 has been determined to contain unique identifiers which are to be validated.

The value returned by the Validator module 78 is sent to the Mapper module 86 which is arranged to return a corresponding UID-Tag. For example, in a transaction environment a POS-entity (e.g. an entity which is in a format that can be processed by a POS terminal 3) may be associated with a unique identifier (UID). The relationship between the UID and associated POS-entity is noted in the UID-tag which is a data record comprising the POS-entity and UID metadata associated with the UID in question.

The UID-Tag returned by the Mapper module 86 may then be sent to a Modifier module 82 which is arranged to modify the intercepted data stream between the scanner 7 and the POS terminal 3. At this point, Modifier module 82, depending on given UID-Tag can modify data stream.

During a print operation, the POS terminal 3 may send data to the printer 5 comprising transaction data that may be modified by the computing device 44 according to the embodiment of the present invention. For example, the transaction data may comprise static barcode data that the computing device 44 may modify and replace with unique barcode data.

During the print operation the packet data from the POS terminal 3 to the printer 5 is sent to the Interceptor module 70 and then to the Router module 72 as per the above description. The UID Provider module 76 may then be called by the Router module 72.

The UID Provider module 76 is arranged to return a unique identifier. The identifier returned by the UID Provider module 76 is then passed to the Modifier module 82 which is arranged to modify intercepted data stream between POS terminal 3 and printer 5.

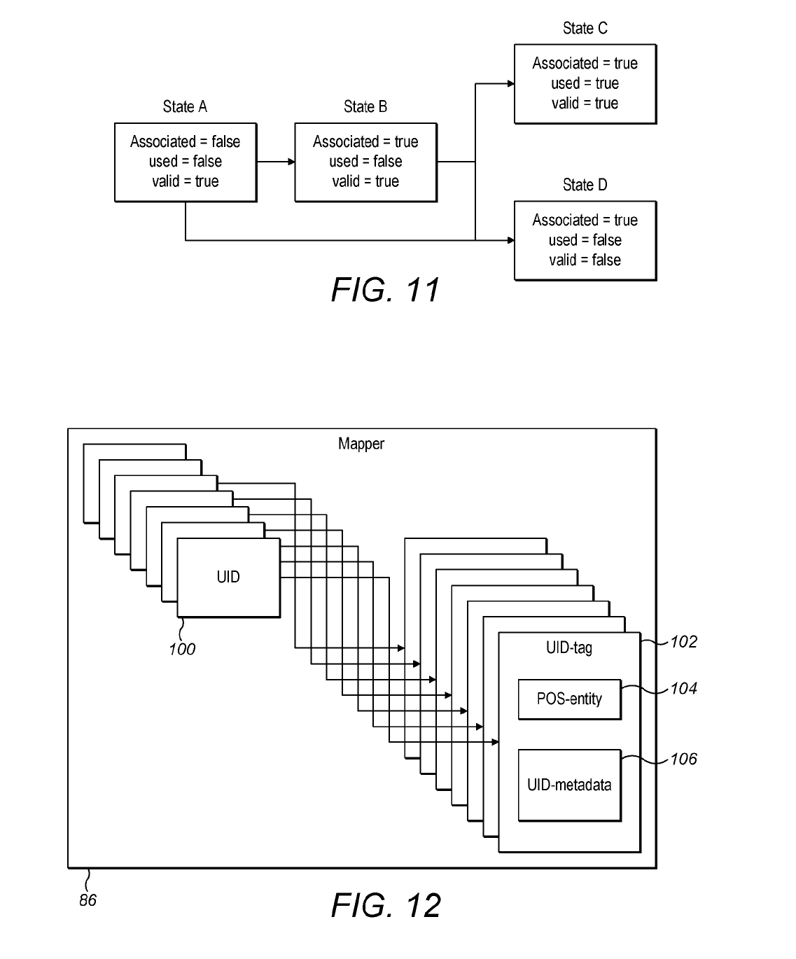

After the data stream has been modified, the modifier module 82 may be arranged to call the UID State Manager module 80 which is arranged to update the state of the UID (see FIG. 11 and the description below for more details on the UID state).

When the data that is intercepted between the POS terminal 3 and the printer 5 comprises receipt data then the Burner module 88 may be called by the Router module 72. The burner module 88 may then call the UID state mapper module 86 to further update the state of the identifier.

The Writer module 74 is arranged to store intercepted data in a data store for use during the read and scan processes (as described in more detail below).

In a transaction environment a user may also be associated with a customer identifier via, for example a loyalty card. The computing device 44 according to an embodiment of the present invention may also operate upon a customer identifier to retrieve unique identifiers (UIDs) associated with the user.

The computing device therefore comprises the Customer Offer (CO) Manager module 90 which is arranged to determine customer identifier (e.g. loyalty card number) data within an intercepted data packet. The customer identifier can be used by the CO Manager module 90 to query a CID Mapper module 92.

The CID Mapper module 92 is arranged to return a customer unique identifier (CUID) and then to use this customer unique identifier to query the COA Mapper module 94 for a set of UID-Tags associated with the given CUID. The CID mapper module 94 may also be arranged to update the state of any unique identifiers associated with the user (e.g. not redeemed/redeemed).

FIG. 11 illustrates a series of states that a unique identifier may take within the POS system according to embodiments of the present invention.

In State A, a unique and valid identifier exists within the system (valid=true). However, this unique identifier has neither been associated with a POS entity (e.g. the unique identifier has not been paired with, for example, a static barcode in a format that may be processed by the POS terminal) nor used (associated=false and used=false).

In State B, the identifier has been associated with a POS entity. A UID-tag will have been created at this point comprising UID metadata associated with the unique identifier and the relevant POS entity. This association may be performed prior to any user interaction with the POS terminal and may, for instance, correspond to a store creating an offer for a given transaction item. This change to state B therefore represents the offer being loaded via the back-office servers 11 into the POS system and will be recorded by the UID state manager module.

State C comprises an identifier that has been redeemed (the used field has been updated from false in state B to true in state C). State D comprises an identifier which has expired (the valid field has been updated from true in state B to false in state D).

It is also noted that a “valid” UID in State A or a valid and associated UID in State B may transition automatically to State D when the corresponding UID expires. For example, a UID might have an expiry date and as the expiry date is reached and then exceeded the UID may transit from State A or State B into State D. The UID state manager module 80 may be arranged to update the UID state of UIDs in such situations.

FIG. 12 shows an example of the data structure of the mapper module 86 which stores (or otherwise can access) the associations between unique identifiers (UIDs) 100 and UID-tags 102 comprising a POS-entity 104 and UID-metadata 106.

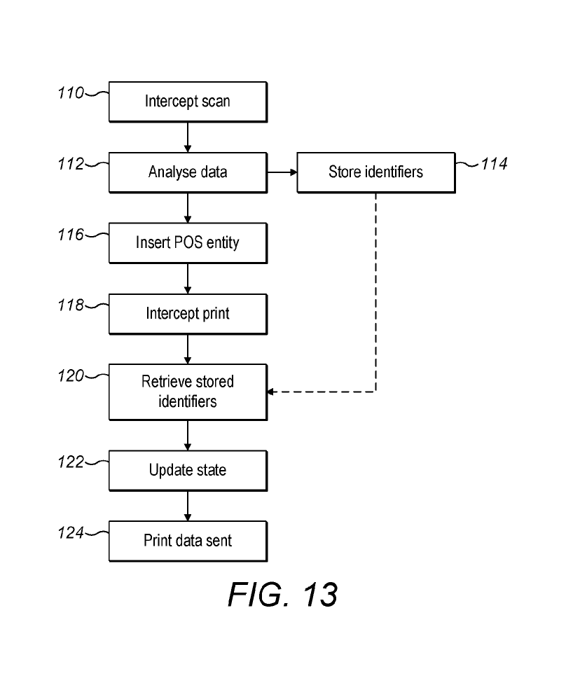

FIG. 13 shows an overview of a method of redeeming a unique identifier 100 during a transaction in accordance with an embodiment of the present invention.

In step 110 scan data is intercepted as it moves from the scanner 7 to the POS terminal 3. In step 112, the intercepted data is analysed by the processor 64 for unique identifiers 100 and a lookup of the identifiers is performed to locate any associated POS-entities 104. The state information is also determined as part of the look up and in the event that the unique identifier is not valid then the process is terminated. A copy of the unique identifiers are also stored in step 114 for use later in the process.

In step 116 the POS entity 104 determined during the lookup process of step 112 is inserted into data packet to be sent to the POS terminal 3. Steps 110 to 116 comprise the scanning phase.

In step 118 a print event corresponding to a completed transaction is intercepted and the print data sent to the processor 64 within the computing device 44.

In step 120 the stored unique identifiers 100 (from step 114) are retrieved and compared with transaction data in the print event in order to determine unique identifiers that have been used during the transaction.

In step 122 the state of the unique identifiers that have been used during the transaction are updated and in step 124 the print data is sent to the printer 5.

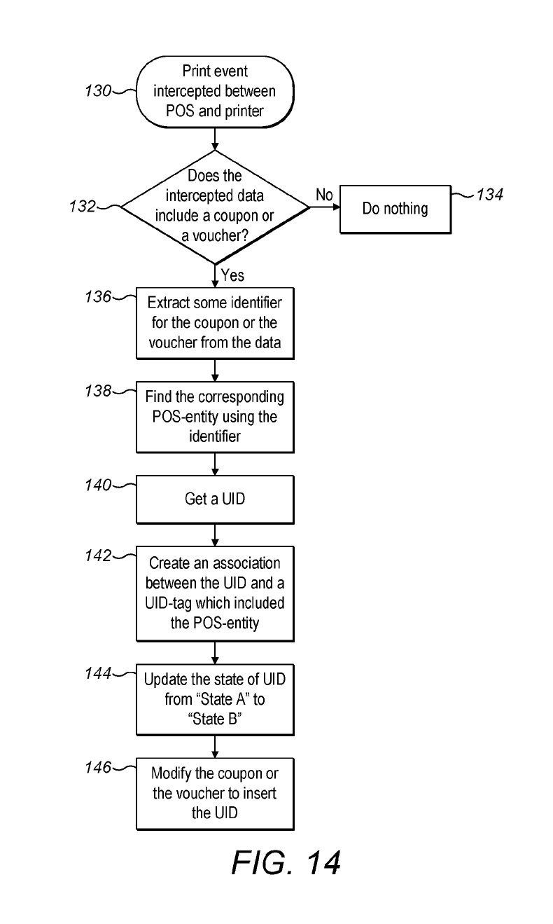

An overview of the process of issuing a unique identifier 100 is shown in FIG. 14.

In step 130 a print event is intercepted between the POS terminal 3 and the printer 5 by the driver software module 40. The print event comprises a data packet having at least one static identifier (e.g. static barcode voucher or coupon).

The print data is sent to the interceptor module 70 within the computing device 44 as part of step 130. The print data is then handed off to the router module 72 which in step 132 checks if the intercepted data comprises a coupon or voucher. In the event that no coupon or voucher is present then the process ends in step 134 and the print data is allowed to pass through to the printer 5.

However, if data corresponding to a coupon or voucher is detected within the print data then in step 136 reference data identifying the identifier is extracted. This reference data may be a static barcode or a header of a coupon or any other piece of data that may uniquely identify the coupon.

The extracted reference data is then used in step 138 to find a corresponding POS-entity.

The router module then in step 140 calls the UID provider module 76 and sends it the POS entity 104 as a parameter in order to get a unique identifier (UID) 100. Essentially in steps 138 and 140 the static barcode is mapped to a unique identifier 100 which is then returned for further use in the system.

The UID provider module 76 then, in step 142 creates (or retrieves) a new unique identifier (UID) 100 and a new UID tag 102. The POS entity 104 is placed within the newly created UID tag 102 by the UID provider 76 which also links the newly created UID and UID-tag. It is noted that the UID provider module 76 may create new unique identifiers 100 in response to the process of FIG. 14. Alternatively, the UID provider module 76 may create a store of unique identifiers 100 in advance of the process of FIG. 14 and then retrieve and allocate these identifiers 100 as needed.

In step 144 the UID provider module 76 calls the UID state manager 80 to update the UID state from state A to state B.

In step 146 the UID provider module 76 returns the unique identifier 100 to the router module 72 which then calls the modifier module 82 to modify the intercepted print data to include the UID 100 in place of the static identifier. This modified transaction data is then sent to the printer 5.

It is noted that the Writer module 74 may be used at this stage to write intercepted receipt data before and after modification into a data store to allow coupon clearance, statistics, etc. to be monitored.

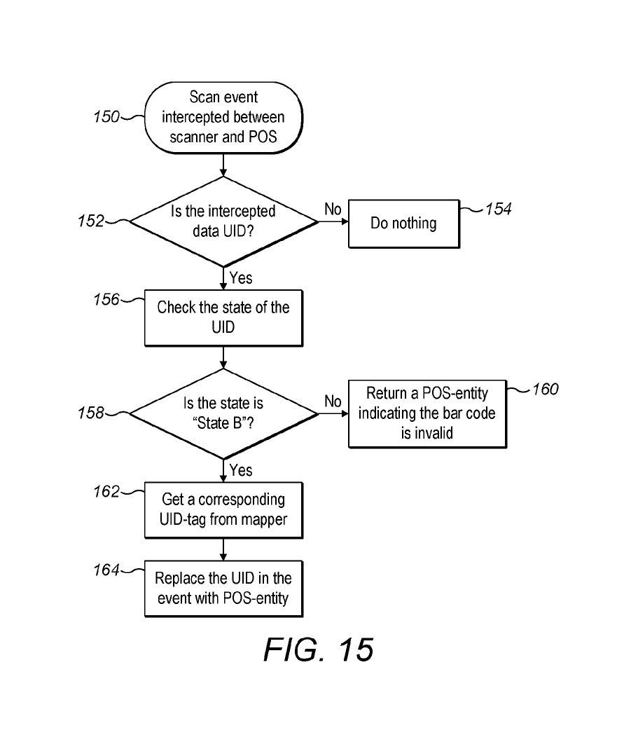

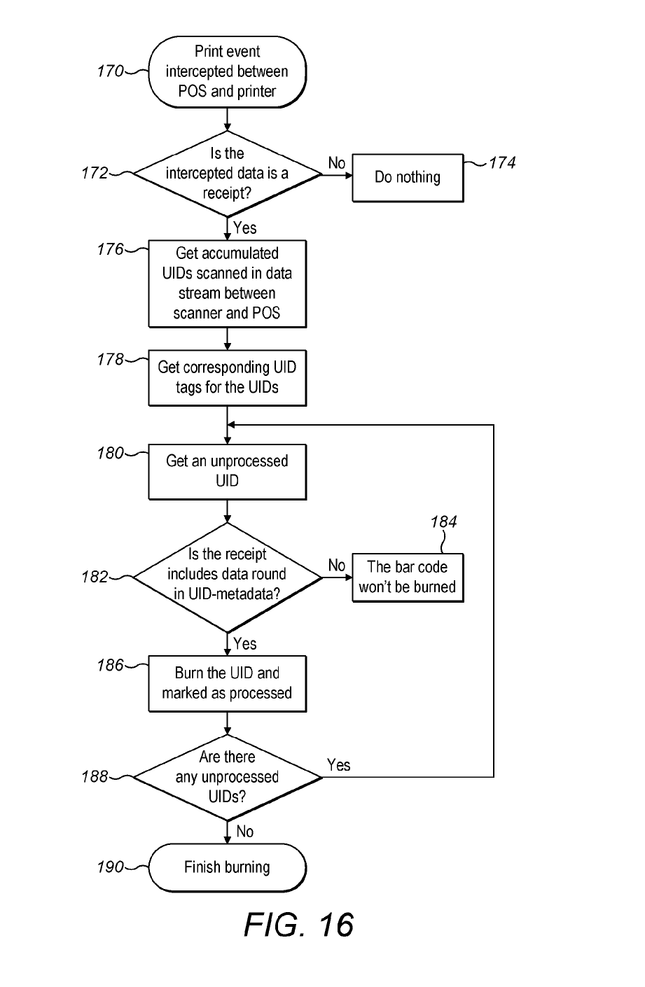

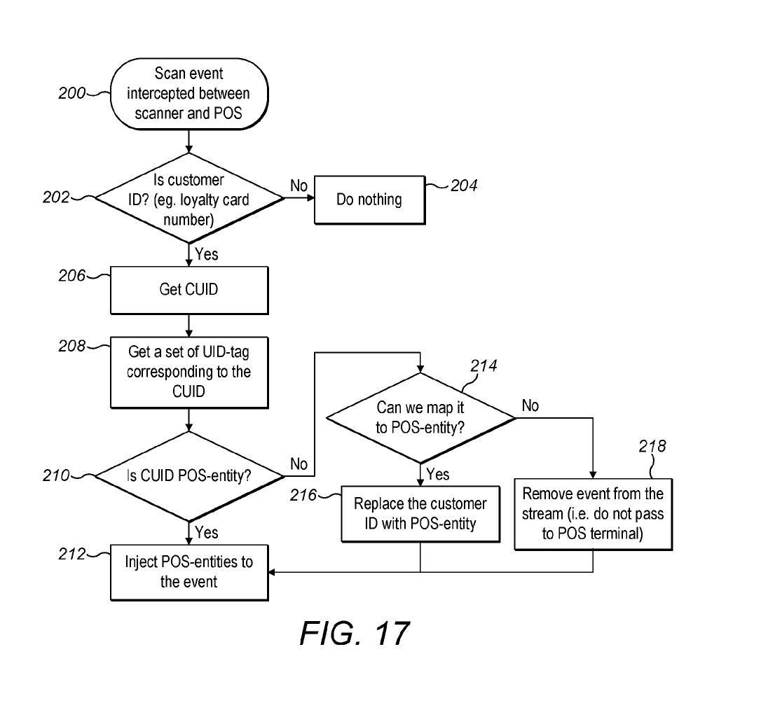

FIGS. 16 and 17 provide an overview of the redemption process for a unique identifier 100 in accordance with embodiments of the present invention. The redemption process comprises two phases, validation (which is illustrated in FIG. 15) and burning (which is illustrated in FIG. 16).

Turing to the validation process shown in FIG. 15, a scan event between the scanner 7 and the POS terminal 3 is intercepted in step 150 by the driver software module 40 which send the scan data to the interceptor module 70.

In step 152 the interceptor module 70 receives the intercepted data and sends it to the router module 72. The router module 72 determines if the intercepted data comprises a unique identifier 100 which has been issued by the computing device 44.

If the router 72 does not determine that there are any unique identifiers 100 within the scan data then the process is terminated and the scan data is allowed to continue unmodified to the POS terminal 3 (step 154).

If one or more unique identifiers 100 are found within the scan data then the router module 72 calls the validator module 78 in order to check the validity of the unique identifier 100 (step 156).

In step 158 the validator module 78 returns the validation result. If the unique identifier is in state B it is valid and may be used in the transaction. However, if the unique identifier 100 is in any of the other states shown in FIG. 11 then it is deemed invalid and this validation result is sent to the modifier 82 in step 160. Depending on the particular nature of the validation state a POS entity 104 indicating this state is sent to the POS terminal 3. For example, if the unique identifier has already been redeemed then it will be in state C and the modifier 82 may send a POS-entity 104 to the POS terminal 3 indicating that the voucher has been redeemed and should not be applied to the transaction.

If the validation result indicates that the unique identifier 100 is valid then this result is sent in step 162 to the mapper module 86 which retrieves a UID-tag 102 corresponding to the scanned unique identifier 100.

The UID-tag 102 is sent to the modifier which may then extract the POS-entity 104 from the UID-tag and substitute the POS-entity into the data sent to the PS terminal in place of the originally scanned unique identifier.

It is noted that the state of the scanned unique identifier is not updated at this point since it is possible for the transaction to be cancelled with the consequence the unique identifier 100 has not been redeemed. However, the unique identifier present in the scan event data is stored in the SE Accumulator module 84 until the actual receipt data is sent from the POS terminal 3 to the printer 5 (in the burning phase described below in relation to FIG. 16). At this point the system can check that the unique identifier has actually been redeemed. If the receipt is not printed, then it is not possible to update the states of the scanned unique identifier, because redemption was not complete.

Turning to the burning process shown in FIG. 16, a print event between the POS terminal 3 and the printer 5 is intercepted in step 170 by the driver software module 40 which sends the print data to the interceptor module 70 which in turn passes it to the router module 72.

In step 172 the router 72 determines if the print data relates to a receipt. In the event that no receipt data is present (e.g. a cancelled transaction) the, in step 174, the process is terminated and the print data is allowed to pass on to the printer 5 unmodified.

In the event that the print data comprises receipt data, then, in step 176, the router module 72 retrieves all the unique identifiers 100 that were previously captured during the scan process shown in FIG. 15 and stored in the SE Accumulator 84 and sends the data to the burner module 88.

In step 178, the UID-tags 102 corresponding to the unique identifiers (UID) 100 in the SE Accumulator 84 are retrieved using the mapper module 86.

In step 180 the burner module 88 selects one of the available unprocessed unique identifiers from the SE accumulator module 84 and calls a matcher module 85 which takes as its input the receipt data and the UID-tag corresponding to the selected unique identifier 100. The UID-tag comprises UID metadata such as a voucher or coupon name or a promotion name. If the UID metadata is found in the receipt data then the matcher module 85 returns a “present on receipt” result. In the event that the receipt data does not include the UID metadata then the matcher module 85 returns a “Not present on receipt” result and the state of the selected unique identifier is not updated (step 184).

However, where a “Present on receipt” result has been returned to the burner module 88 by the matcher module 85 then in step 186 the burner module calls the UID state manager module 80 to update the identifier state from state B to state C. The SE accumulator 84 is cleared of the selected identifier and then, in step 188, the burner checks if there are any further unprocessed unique identifiers. In the event that there are unprocessed identifiers then the process cycles back to step 180 and repeats until all identifiers have been processed.

Once all the identifiers have been processed the process moves to step 190 and terminates.

A further embodiment of the present invention provides for the provision of an offer redemption process.

Turning to the redemption process shown in FIG. 17, a scan event between the POS terminal 3 and the scanner 7 is intercepted in step 200 by the driver software module 40 which sends the scan data to the interceptor module 70 which in turn passes it to the router module 72.

In step 202, the router detects the presence of a unique identifier within the scanned data and passes this to the CO Manager 90. The CO Manager in turn queries the CID Mapper 92 for a customer unique identifier (CUID) associated with this unique identifier.

If there is no CUID associated with this identifier (step 204) then the process terminates and the scan data is allowed to pass through to the POS terminal.

If a CUID result is present then this is returned from the CID mapper 92 in step 206.

In step 208, the COA Mapper 94 is queried for a set of UID-Tags associated with the CUID

The set of UID_tags is sent to the Modifier 82 in step 210 where the Modifier module 82 checks whether the customer unique identifier comprises a POS-entity.

If the customer unique identifier comprises a POS-Entity 104 then this is passed, in step 212 to the POS terminal 3.

If in step 210 the modifier module 82 determines that no POS-entity 104 is present, then, in step 214 the modifier module 82 attempts to map the customer unique identifier to a POS-entity 104. If the mapping process is successful then in step 216 the customer unique identifier is replaced with a POS-entity 104. If the mapping is not successful then the identifier is removed from the data stream in step 218 and remaining data is sent to the POS terminal 3.

During the process shown in FIG. 17 the customer unique identifier may be stored in the SE Accumulator module 84. The POS_entities 104 that are placed into the scanned data stream by the modifier module 82 are applied by the POS terminal 3 which then sends receipt data to the printer 5. The print data may be intercepted and analysed to determine which offers have been applied. The states of the unique identifier associated with the customer unique identifier may then be updated using the CO Manager module 90.

A loyalty scheme comprising the award of customer points may also be managed in accordance with a further embodiment of the present invention. An identifier may be scanned as per the description relating to FIG. 17 above. When the driver software module 40 intercepts the print data at the end of the transaction a data pair comprising the intercepted receipt data and the customer identifier may be made and sent to a processing module that is arranged to award points to the user based on the contents of the receipt data.

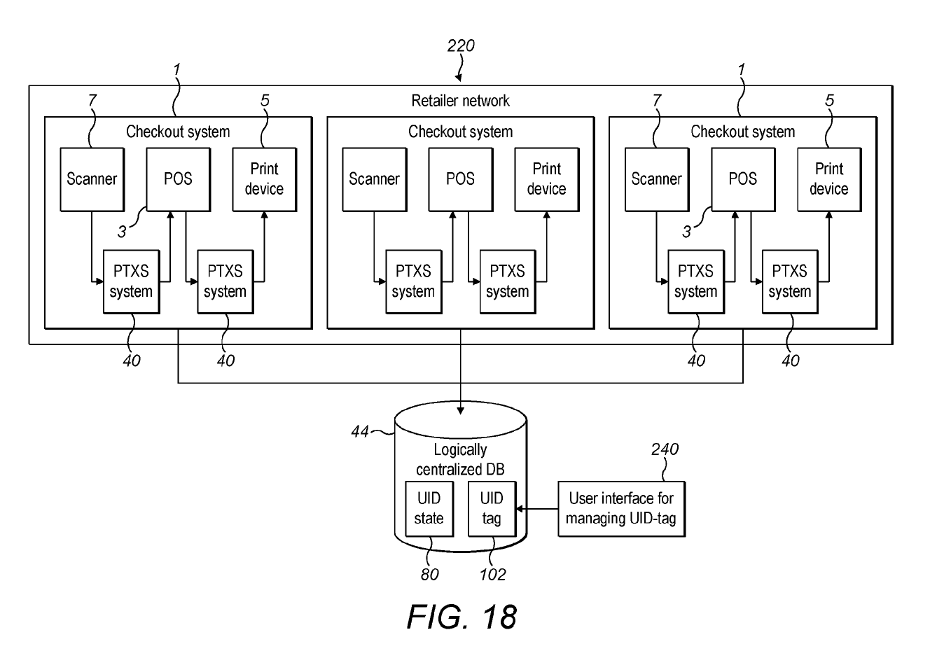

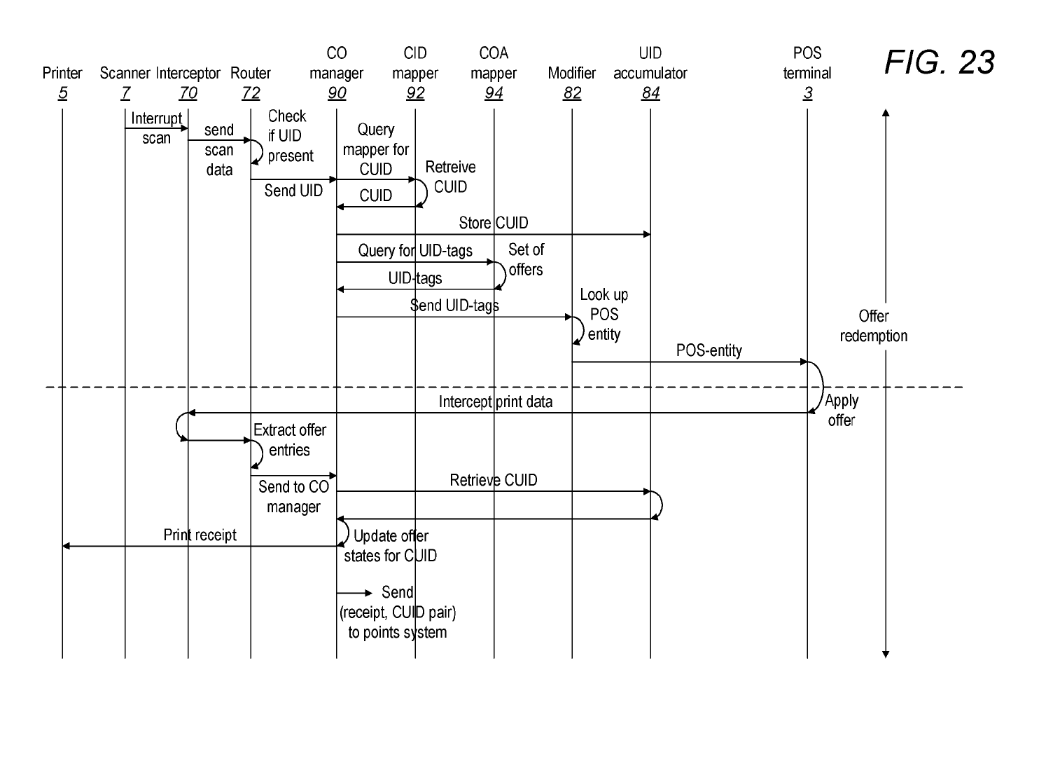

Further detailed descriptions of embodiments of the present invention are described below in the context of a “dynamic barcode” issuance and redemption process (described in conjunction with FIGS. 18 to 22) and an automatic coupon/voucher redemption using customer identifier process (described in conjunction with FIG. 23).

### Scenario 1

### Dynamic Barcode Issuance and Redemption

FIG. 18 shows an architectural layout of an embodiment of the present invention in the context of a typical retailer checkout system.

The retailer system 220 comprises three POS terminals 3, each having its own scanner 7 and printer device 5. A driver software module 40, as described above, operates in the data path between the scanner 7 and POS terminal 3 and printer 5 and POS terminal 3 as previously described. For ease of reference however the driver software module 40 is shown twice within each POS terminal arrangement.

The retailer system 220 of FIG. 18 comprises a computing system 44 (as described above) which manages the state of unique identifiers and also UID-tags 102 (that link UIDs to standard POS entities 104).

A known retailer system may be equipped with a static voucher and coupon issuance and redemption system (referred to herein as a Static Coupon System, SCS), which prints vouchers and coupons 230 with barcodes 232 in the known EAN13 format and a Voucher/Coupon header 234 (see FIG. 19). It is noted that within such a known retailer system the EAN13 barcode and Voucher/Coupons names will be the same per campaign.

Each POS terminal 3 within this known Retailer Network 220 may then be configured to redeem such coupons and vouchers 230 by scanning the EAN13 barcode 232 printed on them. When a coupon or voucher is redeemed, its name 236 is printed on the receipt 238 (see FIG. 20).

The functionality of the above described retailer network 220 may be enhanced in accordance with embodiments of the present invention via the incorporation of the driver software module 40 into the POS terminals 3 of the checkout systems. The presence of the driver software module 40 enables communication with the computing device 44 which in turn effectively enables the POS retailer system 1 to issue and redeem vouchers and coupons with unique, rather than static, identifiers 100 in form of CODE128. It is noted that this enhancement in the functionality of the POS system may be achieved without modification of the default POS software or hardware that is installed on the “out of the box” checkout systems. Instead the driver software module is installed as a separate, additional software component to enable communication with the computing device 44.

Within the retailer network environment 220 of FIG. 18, each instance of the driver software module 40 is arranged to be in communication with a centralized data store 44 which is accessible for every till within the Retailer Network. This data store is arranged to store UID-Tags and UID states. UID states can only be altered by the UID state manager module 80 as described herein.

UID-Tags 102 stored in this data store may be managed by a user interface 240. A UID-Tag in this case is a pair of data elements (a barcode 232 in EAN13 format and a Voucher/Coupon Name 236). It is noted that a barcode in EAN13 format corresponds to a POS-Entity as described herein and the Voucher/Coupon Name corresponds to the UID-Metadata 106 components described herein,

A unique identifier 100 issued in accordance with embodiments of the present invention may be in CODE128 format which enables voucher/coupon/barcodes issued within the retailer network to be unique.

The User interface 240 may be used to set UID-Tags 102, i.e. the user interface may be arranged to allow transaction offers and voucher/coupons to be uploaded and enabled within the retailer network 220.

The process of issuance, redemption and “burning” of unique identifiers issued in accordance with embodiments of the present invention within the retailer network of FIG. 18 are now described.

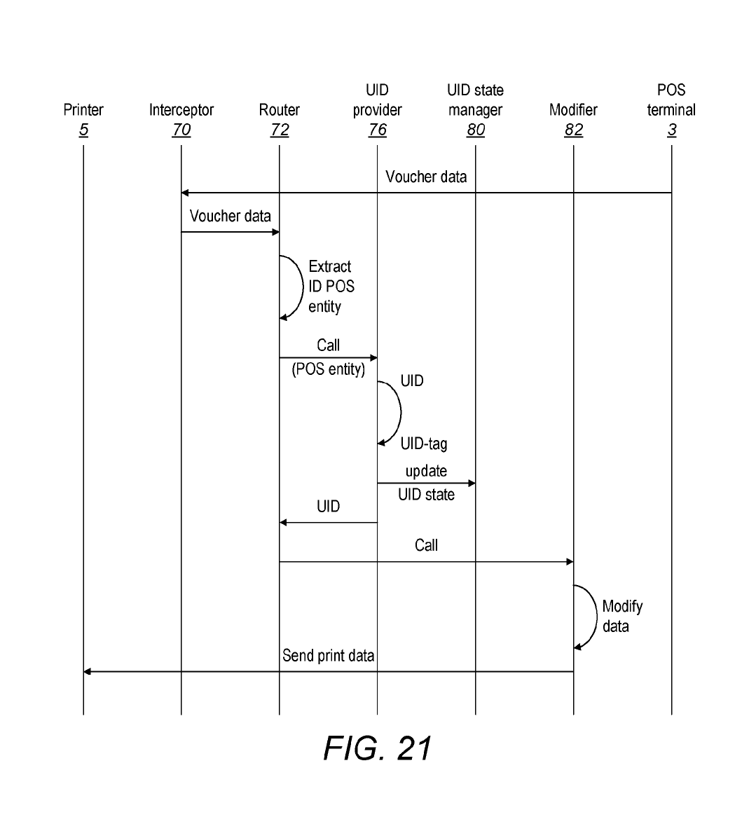

Turning to FIG. 21, the process of issuance of a unique barcode 100 (a “unique identifier”) in accordance with an embodiment of the present invention is described.

It is noted that when a coupon or a voucher 230 is issued by the known static coupon system (POS terminal 3), the barcode 232 is in EAN13 format. The barcode also comprises a header 234 (see FIG. 19) which can be detected by the router module to thereby allow a unique identifier to be substituted.

Turning to FIG. 21, the POS terminal 3 issues a static barcode/identifier 232 and sends a print command to the printer 5.

The driver software module 40 is arranged to pass the print data to the interceptor module 70 which in turn sends the print data to the router module 72. The header 234 within the barcode 232 is detected by the router module 72. The router module then extracts the EAN13 barcode (the POS entity 104) from the print data.

The router 72 then calls the UID provider 76 and sends the POS entity 104. The UID provider gets a unique identifier (UID), which may be in CODE128 format, and associates this unique identifier 100 with a corresponding UID-Tag 102 (the UID-tag comprising the original POS Entity 104 and UID metadata 106 such as the voucher name).

A call is put to the UID state manager module 80 to change the state of the UID from state A to state B.

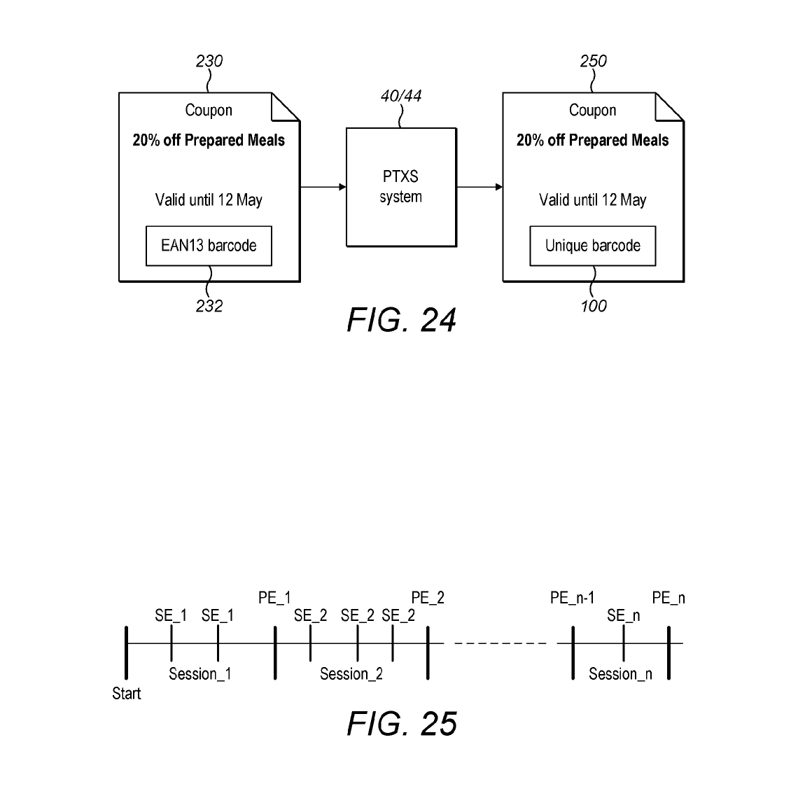

The unique identifier 100 is then sent to the router module 72 which calls the modifier module 82 which is then arranged to modify the print data to include the unique identifier (e.g. CODE128) instead of the original static identifier (e.g. EAN13). The print data is then sent to the printer 5 and a coupon 250 with a unique barcode 100 is then printed (see FIG. 24).

The writer module 74 shown in FIG. 10 may also be used at this stage to write intercepted receipt data before and after modification into a data store for coupon clearance, statistics, etc. The data store may store intercepted vouchers, coupons, or receipts, or other relevant information in data store.

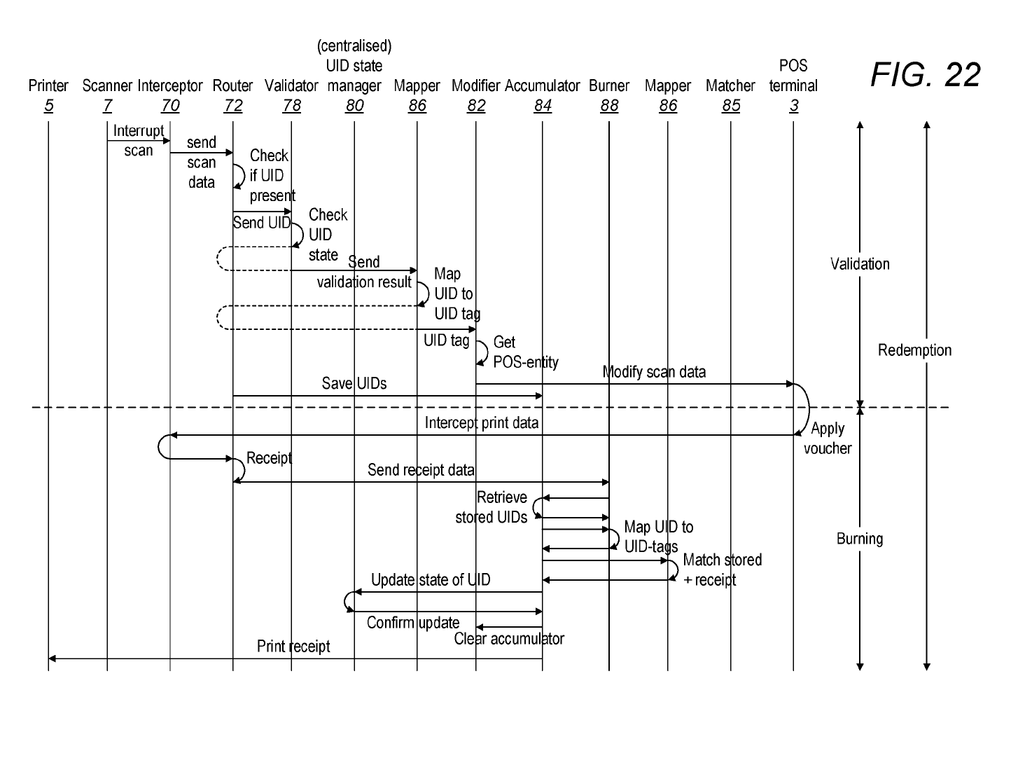

The process of voucher (identifier) redemption and burning are shown in FIG. 22.

Turning to FIG. 22, when a unique identifier 100 issued in accordance with the process described in relation to FIG. 21 is redeemed, it is scanned at the scanner device 7. (The “mapper module” feature is shown twice in FIG. 22 in order to improve the clarity of the figure).

A known POS terminal 3 is arranged to process identifiers in EAN13 format and so will not be able to process such an identifier 100 without the presence of the driver software module 40 and the computing device 44 as described above.

The scanned barcode data is passed to the interceptor module 70 from the driver software module 40. This data is sent to the router module 72 which is arranged to be capable of distinguishing between static (e.g. EAN13) barcodes and dynamic identifiers (e.g. CODE128).

The router module 72 is arranged initially to check if the scanned data comprises a unique identifier 100. In the event that a unique identifier (UID) is present this is sent to the validator module 78 which then checks the state of the unique identifier with the UID state manager 80.

If the unique identifier is not valid then the router module 72 is arranged to send the scan data straight to the modifier module 82 which is arranged to modify the scan data with an identifier, in a format that may be processed by the POS terminal, that indicates that the code is invalid.

If the unique identifier (e.g. CODE128) is found, following the UID state manager 80 check, to be valid then the router module is arranged to call the mapper module 86 to map the unique identifier (UID) 100 to its corresponding UID-Tag 102.

The unique identifier is then sent to the modifier module 82 to obtain the POS-entity (e.g. EAN13 format barcode) that corresponds to the unique identifier. The modifier module may then modify the scanned data to replace the unique identifier data with the corresponding static identifier data. The POS terminal 3 may then process the voucher/barcode in the normal manner and apply the voucher/barcode to the transaction being processed.

The router module 72 is also arranged, as part of the redemption process, to store (in the accumulator module 84) the unique identifiers 100 present in the scanned data for use in the burning process described below.

The burning process relates to the modification of the stored state of the unique identifier to prevent multiple uses of the same unique identifier.

Following processing of the transaction the POS terminal 3 sends print data to the printer. If the redemption of the static identifiers 232 was successful then the receipt 238 will include redeemed coupon name (or names; if there were multiple coupons/vouchers).

The print data is intercepted in the manner described above and sent from the interceptor module 70 to the router module 72.

The Router module 72 is arranged to be capable of recognising the print data as relating to a receipt 238 and to process the print data further.

The receipt data is sent to the burner module 88 which is arranged to retrieve the stored unique identifiers identified in the scanned data from the SE Accumulator 84.

The burner module 88 is then arranged to call the mapper module to map the unique identifiers to their corresponding UID-tags.

The burner module 88 is then arranged to select one of the available unprocessed unique identifiers 100 from the SE accumulator module 84 and call a matcher module which takes as its input the receipt data and the UID-tag corresponding to the selected unique identifier. The UID-tag 102 comprises UID metadata 106 such as a voucher or coupon name or a promotion name. If the UID metadata is found in the receipt data then the matcher module returns a “present on receipt” result.

For every such “present on receipt” result the UID state manager 80 is called in order to change the state of the unique identifier in question from state B to state C. This process of matching the stored UID data to the receipt data continues until there are no more matches left. The SE Accumulator module 84 may then be emptied.

It is noted that if the Accumulator module 84 comprises multiple unique (e.g. CODE128) identifiers and the receipt has multiple Voucher/Coupon names then the computing device may be arranged to try and match them greedily.

If a transaction is cancelled, then the scanned identifiers will not be redeemed. The computing device 44 may be arranged to detect such cases by inspecting the intercepted receipt data for patterns such as Cancelled Transaction, etc. In such instances the SE Accumulator module 84 may be cleared without calling the UID state manager module 80 to changing any identifier states.

The computing device 44 may also be arranged to store receipt data in a data store for later processing. This data store may also be easily used for coupon-clearance, since all information about POS, time and other useful information is usually present on a receipt, which can be saved in the data store.

A further embodiment of the present invention is described in relation to FIG. 23 in which a user's identity (e.g. via a customer loyalty card) may be used to enable an automatic coupon/voucher redemption process.

In relation to FIG. 23 it is assumed that a user has an account within a User Account Management System (UAM System) and that the user has received an offer via, for example, a magazine by scanning a QR-code printed in it or by typing in some promotion code at an offer managements system user interface or by some other means (such as Facebook, Twitter, etc).

In the present embodiment it is assumed that a QR-code has been scanned using a mobile device (e.g. a smartphone, tablet or other suitable computing device) and an application installed on the mobile device has associated the offer represented by the QR code with the user's customer unique identifier (CUID) by communicating with UAM System. This CUID is also mapped to user's loyalty card number.

Turning to FIG. 23, a loyalty card is scanned as part of a transaction. The scanned data is passed via the driver software module 40 to the interceptor module 70 and then to the router module 72.

The router module 72 is arranged to detect the presence of the loyalty card number (a unique identifier which is related to the customer unique identifier) within the intercepted data and to send this data to the Customer Offer Manager (CO Manager) module 90.

The CO Manager module 90 is arranged to query the CID Mapper module 92 by passing it the loyalty card number.

The CID Mapper module 92 is then arranged to retrieve the customer unique identifier (CUID) associated with the loyalty card number.

It is noted that if there is no CUID associated with the loyalty card number then the process can terminate. However, if a CUID is present then this is stored in the SE accumulator 84 for later use at offer state (as described below).

The CO Manager module 90 is then arranged to query the COA mapper module 94 for a set of offers (a set of UID-Tags 102) associated with the given CUID.

The COA Mapper module 94 is arranged to return a set of offers (UID-Tags) which are then sent to the Modifier module 82.

The Modifier 82 is arranged to look up POS_entities 104 associated with the UID tags and then inject these POS-Entities into the data stream between the Scanner 7 and POS Terminal 3.

At this point, the POS Terminal software 17 may apply the applicable offers to the current transaction.

Following the completion of the transaction, the POS Terminal 3 sends receipt data to the printer 5.

This print data may be intercepted in a manner similar to that described above and the redeemed offers within the receipt data may be extracted by the router module 72.

These offers may be sent to the CO manager module 90 which retrieves the customer unique identifier that has been stored in the SE accumulator 84.

The CO Manager module 90 may then update the states of redeemed offers in the customer account.

Note that in case when a user identity number (loyalty card number, in this case) is printed on the receipt it is possible to omit the step of storing CUID in SE Accumulator 84 and extract the loyalty card number directly from the intercepted receipt and use CID Mapper 92 to map it to a CUID.

It will be understood that the embodiments described above are given by way of example only and are not intended to limit the invention. It will also be understood that the embodiments described may be used individually or in combination.

1. A transaction computing device for interacting with a POS system, the POS system comprising a POS terminal having a software module for processing transactions within a transaction environment and a physical device in communication with the POS terminal, the transaction computing device comprising:
an input for receiving transaction data from the physical device
a processor arranged to process the received transaction data to generate modified transaction data
an output arranged to send the modified transaction data to the POS terminal wherein the processor is arranged to
determine whether the received transaction data is associated with a unique identifier
and, in response to determining the presence of an associated unique identifier, determine the state of the unique identifier
in response to the unique identifier being valid, retrieve a modified identifier, the modified identifier being in a format compatible with the POS terminal
generate modified transaction data, the modified transaction data comprising the modified identifier.

2. A transaction computing device as claimed in claim 1, further comprising a data store wherein the computing device is arranged to store unique identifiers present in the received transaction data.

3. A transaction computing device as claimed in claim 1 or claim 2, wherein the input is arranged to receive further transaction data relating to a completed transaction; and wherein the processor is arranged to determine whether the further transaction data comprises a transaction entity corresponding to the unique identifier and, in response to determining the presence of such a transaction entity to update the state of the unique identifier.

4. A transaction computing device as claimed in claim 3, wherein the state of the unique identifier is updated from valid to used.

5. A transaction computing device as claimed in claim 4, wherein the computing device is in communication with a storage module that is arranged to store the state of the unique identifier.

6. A transaction computing device as claimed in claim 5, wherein the storage module is remotely located from the POS system.

7. A transaction computing system as claimed in any preceding claim, wherein the physical device is a scanner.

8. A transaction computing device as claimed in any preceding claim, wherein the input is arranged to receive transaction data from a plurality of POS systems and wherein the processor is arranged to process transaction data received from each of the plurality of POS systems and return modified transaction data to each of the plurality of POS systems.

9. A transaction computing device as claimed in any preceding claim, wherein the input is arranged to receive further transaction data relating to a completed transaction and wherein the processor is arranged to determine whether the further transaction data comprises a plurality of transaction entities, each transaction entity corresponding to a unique identifier, and, in response to determining the presence of a first transaction entity, to update the state of the unique identifier corresponding to the first transaction entity and wherein the processor is arranged to repeat the determining and state updating for each transaction entity identified in the received further transaction data.

10. A transaction computing device as claimed in claim 3 or claim 9, wherein the further transaction data is received from the POS terminal.

11. A transaction computing device as claimed in any preceding claim, wherein the processor is arranged to determine the state of the unique identifier by accessing a look up table that comprises details of all issued unique identifiers

12. A transaction computing device as claimed in any preceding claim, wherein the unique identifier comprises barcode data in a format incompatible with the POS terminal and wherein the modified identifier comprises barcode data in a format compatible with the POS terminal.

13. A transaction computing device as claimed in any one of claims 1 to 11, wherein the unique identifier within the transaction data comprises a loyalty number from a scanned loyalty card and wherein determining the state of the unique identifier comprises determining if the unique identifier is linked to a transaction redemption offer.

14. A transaction computing device for interacting with a POS system, the POS system comprising a POS terminal having a software module for processing transactions within a transaction environment and a physical device in communication with the POS terminal, the transaction computing device comprising:
an input for receiving transaction data from the physical device
a processor arranged to process the received transaction data to generate modified transaction data
an output arranged to send the modified transaction data to the POS terminal wherein the processor is arranged to
determine whether the received transaction data comprises a unique identifier in the form of barcode data
and, in response to determining the presence of a unique identifier, determine the state of the unique identifier
in response to the unique identifier being valid, retrieve a modified identifier, the modified identifier comprising further barcode data in a format compatible with the POS terminal
generate modified transaction data, the modified transaction data comprising the modified identifier.

15. A transaction computing device as claimed in claim 14, wherein the input is arranged to receive further transaction data from the POS terminal relating to a completed transaction; determine whether the further transaction data comprises a transaction entity corresponding to the unique identifier and, in response to determining the presence of such a transaction entity to update the state of the unique identifier.

16. A transaction computing device for interacting with a POS system, the POS system comprising a POS terminal having a software module for processing transactions within a transaction environment and a physical device in communication with the POS terminal, the transaction computing device comprising:
an input for receiving transaction data from the physical device
a processor arranged to process the received transaction data to generate modified transaction data
an output arranged to send the modified transaction data to the POS terminal wherein the processor is arranged to
determine whether the received transaction data comprises a unique identifier in the form of a loyalty number
and, in response to determining the presence of a unique identifier, determine if the loyalty number is associated with a transaction redemption offer; and
in response to the loyalty number being associated with a transaction redemption offer, retrieve a modified identifier, the modified identifier comprising redemption offer data in a format compatible with the POS terminal
generate modified transaction data, the modified transaction data comprising the modified identifier.

17. A transaction computing device as claimed in claim 16, wherein the input is arranged to receive further transaction data from the POS terminal relating to a completed transaction; determine whether the further transaction data comprises a transaction entity corresponding to the transaction redemption offer and, in response to determining the presence of such a transaction entity to update the state of the transaction redemption offer.

18. A transaction computing device for interacting with a POS system, the POS system comprising a POS terminal having a software module for processing transactions within a transaction environment and a physical device in communication with the POS terminal, the transaction computing device comprising:
an input for receiving transaction data from the POS terminal
a processor arranged to process the received transaction data to generate modified transaction data
an output arranged to send the modified transaction data to the software module wherein the processor is arranged to
determine whether the received transaction data comprises an identifier for a transaction redemption offer
and, in response to determining the presence of an identifier, create an association between the identifier, transaction redemption offer and a unique identifier; and
generate modified transaction data, the modified transaction data comprising the unique identifier.

19. A method of operating a transaction computing device to interact with a POS system, the POS system comprising a POS terminal having a software module for processing transactions within a transaction environment and a physical device in communication with the POS terminal, the method comprising:
receiving transaction data from the physical device
processing at a processor the received transaction data to generate modified transaction data
sending the modified transaction data to the POS terminal
wherein the processing at the processor comprises
determining whether the received transaction data is associated with a unique identifier
and, in response to determining the presence of an associated unique identifier, determining the state of the unique identifier
in response to the unique identifier being valid, retrieving a modified identifier, the modified identifier being in a format compatible with the POS terminal
generating modified transaction data, the modified transaction data comprising the modified identifier.

20. A method of operating a transaction computing device for interacting with a POS system, the POS system comprising a POS terminal having a software module for processing transactions within a transaction environment and a physical device in communication with the POS terminal, the method comprising:
receiving transaction data from the physical device
processing the received transaction data to generate modified transaction data
sending the modified transaction data to the POS terminal
wherein the processing at the processor comprises
determining whether the received transaction data comprises a unique identifier in the form of barcode data
and, in response to determining the presence of a unique identifier, determining the state of the unique identifier
in response to the unique identifier being valid, retrieving a modified identifier, the modified identifier comprising further barcode data in a format compatible with the POS terminal
generating modified transaction data, the modified transaction data comprising the modified identifier.

21. A method of operating a transaction computing device for interacting with a POS system, the POS system comprising a POS terminal having a software module for processing transactions within a transaction environment and a method computing device comprising:
receiving transaction data from the physical device
processing the received transaction data to generate modified transaction data
sending the modified transaction data to the POS terminal
wherein the processing at the processor comprises
determining whether the received transaction data comprises a unique identifier in the form of a loyalty number
and, in response to determining the presence of a unique identifier, determining if the loyalty number is associated with a transaction redemption offer; and
in response to the loyalty number being associated with a transaction redemption offer, retrieving a modified identifier, the modified identifier comprising redemption offer data in a format compatible with the POS terminal
generating modified transaction data, the modified transaction data comprising the modified identifier.

22. A method of operating a transaction computing device for interacting with a POS system, the POS system comprising a POS terminal having a software module for processing transactions within a transaction environment and a physical device in communication with the POS terminal, the method comprising:
receiving transaction data from the POS terminal
processing the received transaction data to generate modified transaction data
sending the modified transaction data to the software module
wherein the processing at the processor comprises
determining whether the received transaction data comprises an identifier for a transaction redemption offer
and, in response to determining the presence of an identifier, creating an association between the identifier, transaction redemption offer and a unique identifier; and
generating modified transaction data, the modified transaction data comprising the unique identifier.

23. A carrier medium for carrying a computer readable code for controlling a transaction computing device to carry out the method of any one of claims 19 to 22.
